(19) United States
(12) Patent Application Publication
(10) Pub. No.: US 2026/0209437 A1
(43) Pub. Date: Jul. 23, 2026

(54) ANTIMICROBIAL COPOLYMERS AND METHODS OF MAKING AND USE THEREOF

(71) Applicant: Clearlab SG Pte Ltd., Singapore (SG)

(72) Inventors: John Christopher Phelan, Johns Creek, GA (US); Jong Gu Park, Singapore (SG); Yeong Shenq Chow, Singapore (SG); Ji Hye Moon, Singapore (SG)

(21) Appl. No.: 19/453,228

(22) Filed: Jan. 20, 2026

Related U.S. Application Data
(60) Provisional application No. 63/747,424, filed on Jan. 21, 2025.

(51) Int. Cl. C08G 73/06; A01N 43/36; A01P 1/00; C08G 73/10; C08K 3/08; C08K 5/00; C08K 5/17

(52) U.S. Cl. CPC C08G 73/0611; A01N 43/36; A01P 1/00; C08G 73/10; C08K 3/08; C08K 5/0025; C08K 5/17

(57) ABSTRACT

Disclosed herein are antimicrobial copolymers and methods of making and use thereof. For example, disclosed herein are compositions comprising an antimicrobial copolymer derived from diallyldimethyl ammonium chloride (DADMAC), wherein the antimicrobial copolymer comprises a curable or reactive group, and the curable or reactive group is thermally and/or actinically curable. Also disclosed herein are methods of making and methods of use of any of the compositions comprising antimicrobial copolymers described herein. Also disclosed herein are articles of manufacture comprising any of the compositions disclosed herein, for example wherein the article of manufacture comprises a medical device, such as an ophthalmic device, such as a contact lens.

### CROSS-REFERENCE TO RELATED APPLICATIONS

This application claims the benefit of priority to U.S. Provisional Application No. 63/747,424, filed Jan. 21, 2025, which is hereby incorporated herein by reference in its entirety.

### BACKGROUND

Medical devices, such as contact lenses, intraocular lenses, wound dressings, sutures, catheters, endoscopes, ventilator tubes, intravenous lines, and stents, are susceptible to microbial colonization, leading to potential infections, highlighting the need for effective antimicrobial strategies.

Previous attempts to incorporate antimicrobial agents have faced challenges such as cytotoxicity or insufficient long-term efficacy. There is a critical need for antimicrobial materials that do not leach, ensuring sustained antimicrobial activity without adverse health effects.

The compositions, devices, methods, and systems discussed herein address these and other needs.

### SUMMARY

In accordance with the purposes of the disclosed compositions, devices, methods, and systems as embodied and broadly described herein, the disclosed subject matter relates to antimicrobial copolymers and methods of making and use thereof.

For example, disclosed herein are compositions comprising an antimicrobial copolymer derived from diallyldimethyl ammonium chloride (DADMAC), wherein the antimicrobial copolymer comprises a curable or reactive group, and the curable or reactive group is thermally and/or actinically curable. In some examples, the antimicrobial copolymer is derived from diallyldimethyl ammonium chloride (DADMAC) and a curable monomer (e.g., one or more curable monomers), said curable monomer comprising said curable or reactive group. In some examples, the antimicrobial copolymer derived from diallyldimethyl ammonium chloride (DADMAC) and a bifunctional vinylic monomer (e.g., one or more bifunctional vinylic monomers), the bifunctional vinylic monomer comprising said curable or reactive group.

In some examples, the curable or reactive group comprises an ethylenically unsaturated group, a hydroxyl group, an amino group, an epoxy group, a thiol group, or a combination thereof.

In some examples, the curable or reactive group comprises an ethylenically unsaturated group. In some examples, the ethylenically unsaturated group comprises acryloyl, acrylamide, alkyl acrylamide, dialkyl acrylamide, methacryloyl, allyl, vinyl, styrenyl, or a combination thereof.

In some examples, the antimicrobial copolymer is defined by Formula I:

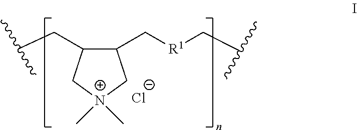

wherein R¹ comprises the curable or reactive group; and n is an integer from 1 to 10,000. In some examples, n is an integer from 50 to 10,000 or from 100 to 10,000. In some examples, R¹ is derived from the curable monomer. In some examples, R¹ is derived from the bifunctional vinylic monomer.

In some examples, the antimicrobial copolymer is defined by Formula II:

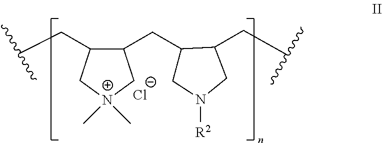

wherein R² comprises the curable or reactive group; and n is an integer from 1 to 10,000. In some examples, n is an integer from 50 to 10,000 or from 100 to 10,000.

In some examples, R² is selected from the group consisting of:

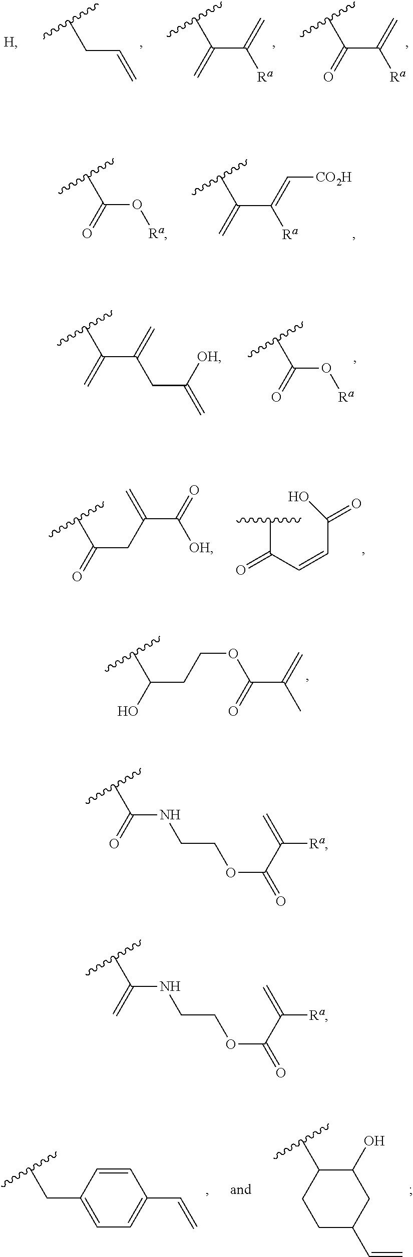

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples, the antimicrobial copolymer comprises a first curable or reactive group and a second curable or reactive group, each of which is thermally and/or actinically curable.

In some examples, the curable monomer comprises a first curable monomer with a first curable or reactive group and a second curable monomer with a second curable or reactive group, such that the antimicrobial copolymer comprises the first curable or reactive group and the second curable or reactive group, each of which is thermally and/or actinically curable.

In some examples, the bifunctional vinylic monomer comprises a first bifunctional vinylic monomer with a first curable or reactive group and a second bifunctional vinylic monomer with a second curable or reactive group, such that the antimicrobial copolymer comprises the first curable or reactive group and the second curable or reactive group, each of which is thermally and/or actinically curable.

In some examples, the first curable or reactive group and/or the second curable or reactive group each independently comprises an ethylenically unsaturated group, a hydroxyl group, an amino group, an epoxy group, a thiol group, or a combination thereof.

In some examples, the first curable or reactive group and/or the second curable or reactive group independently comprises an ethylenically unsaturated group.

In some examples, the first curable or reactive group and/or the second curable or reactive group independently comprises an ethylenically unsaturated group comprising acryloyl, acrylamide, alkyl acrylamide, dialkyl acrylamide, methacryloyl, allyl, vinyl, styrenyl, or a combination thereof.

In some examples, the antimicrobial copolymer is defined by Formula III:

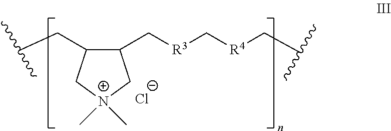

wherein R³ comprises the first curable or reactive group; R⁴ comprises the second curable or reactive group; and n is an integer from 1 to 10,000. In some examples, n is an integer from 50 to 10,000 or from 100 to 10,000.

In some examples, R³ and/or R⁴ are independently selected from the group consisting of:

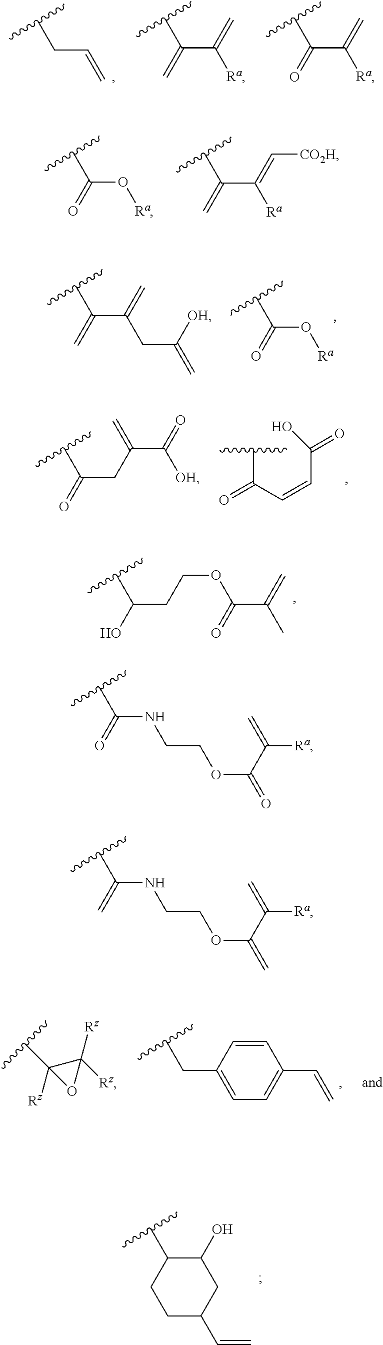

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples, the antimicrobial copolymer is defined by Formula IV:

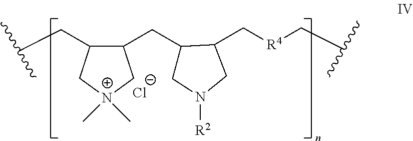

wherein R² comprises the first curable or reactive group; R⁴ comprises the second curable or reactive group; and n is an integer from 1 to 10,000. In some examples, n is an integer from 50 to 10,000 or from 100 to 10,000

In some examples, R² is selected from the group consisting of:

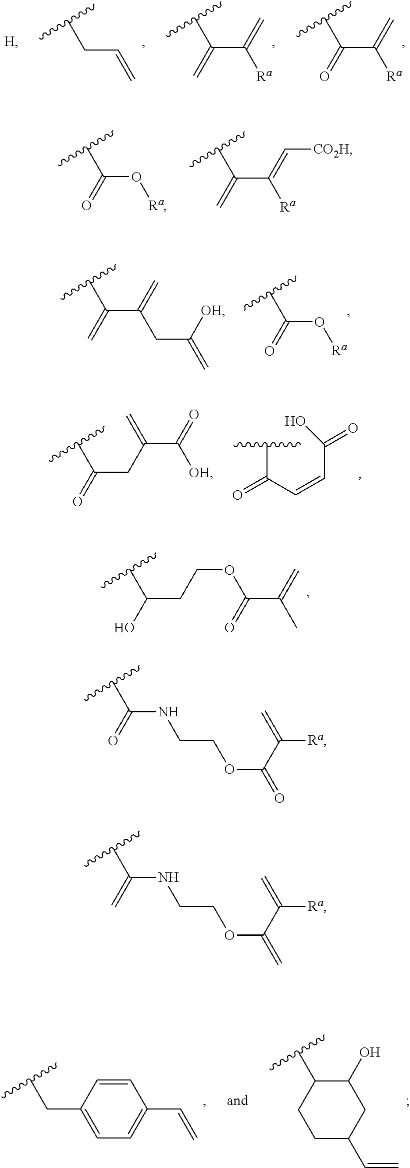

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples, R⁴ is selected from the group consisting of:

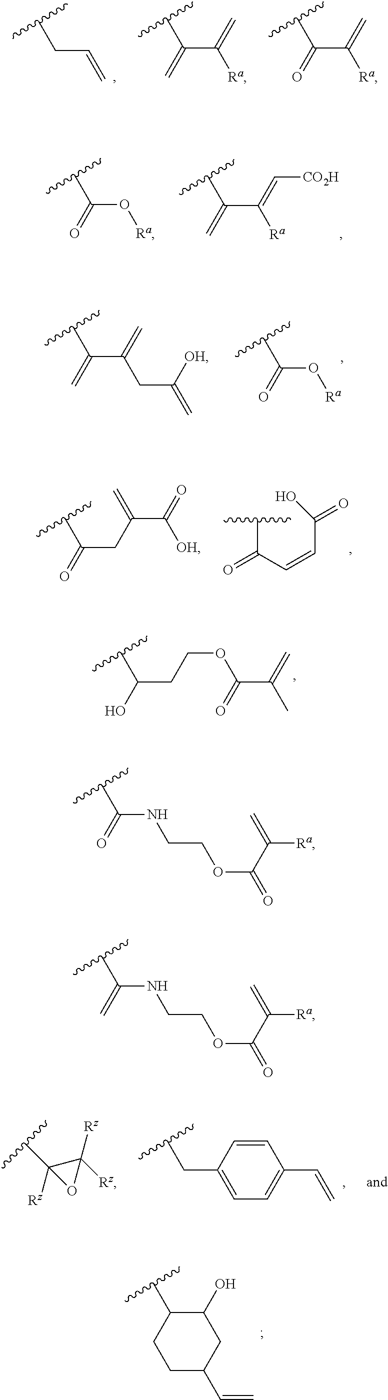

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, 3-(Trimethoxysilyl)alkyl, Hydroxyalkoxy (alkylylbis(trimethylsilyloxy)-methylsilane, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples, the antimicrobial copolymer comprises:

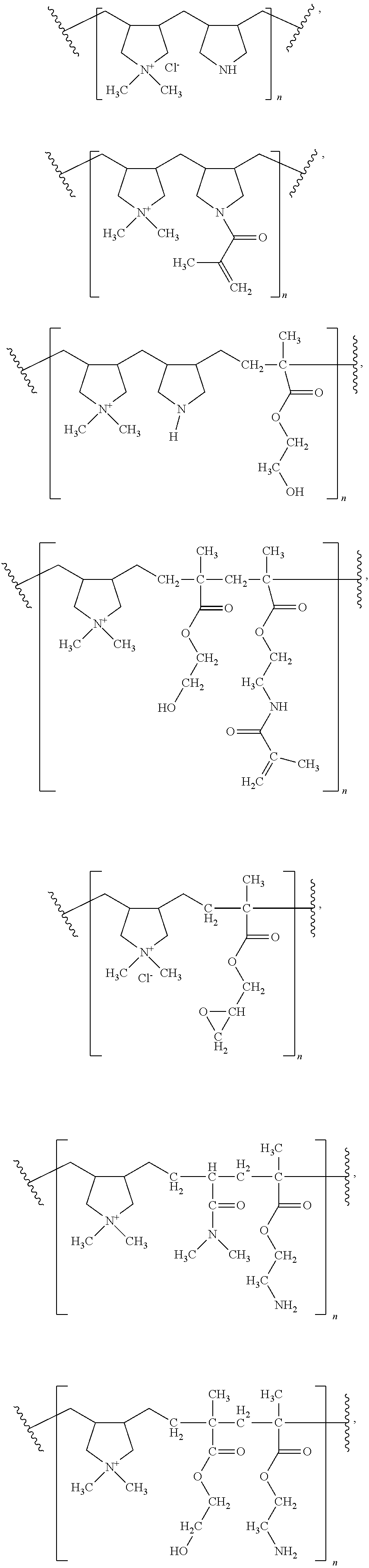

or a combination thereof, wherein each n is independently from 1 to 10,000.

In some examples, the antimicrobial copolymer is further derived from an additional monomer. In some examples, the antimicrobial copolymer is further derived from an additional monomer, wherein the additional monomer comprises a hydrophilic monomer, a hydrophobic monomer, an amphiphilic monomer, a zwitterionic monomer, a macromonomer, an antimicrobial monomer, or a combination thereof. In some examples, the additional monomer comprises diallyl amine, 2-hydroxyethyl methacrylate, 2-aminoethyl methacrylate hydrochloride, glycerolmonomethacrylate, N,N-dimethylacrylamide, N-Hydroxyethyl acrylamide, N-(3-Hydroxypropyl)-acrylamide, N-(2,3-dihydroxypropyl) acrylamide, a quaternary ammonium chloride methacrylamide-functionalized polydimethylsiloxane (QAM-PDMS), a quaternary ammonium chloride methacrylate-functionalized polydimethylsiloxane (QA-MA-PDMS), or a combination thereof.

In some examples, the composition further comprises a chain transfer agent to regulate molecular weight. In some examples, the chain transfer agent comprises 2-mercaptoethanol, butyl mercaptan, dodecyl mercaptan, L-cysteine, dibutyl disulfide, tertiary-dibutyl disulfide, or a combination thereof.

In some examples, the composition further comprises an initiator, a crosslinker, an additional monomer, a UV-blocker, a blue light blocker, a dye, a pigment, a solvent, an additional antimicrobial agent, or a combination thereof.

In some examples, the composition further comprises an additional antimicrobial agent. In some examples, the additional antimicrobial agent comprises a quaternary ammonium compound, an antimicrobial metal, or a combination thereof. In some examples, the additional antimicrobial agent comprises a quaternary ammonium compound. In some examples, the additional antimicrobial agent comprises an antimicrobial metal comprising Ag, Au, Pt, Pd, Ir, Sn, Cu, Sb, Bi, or Zn. In some examples, the additional antimicrobial agent comprises a plurality of nanoparticles comprising the antimicrobial metal.

In some examples, the composition is non-leaching.

In some examples, the composition exhibits antimicrobial activity.

In some examples, the composition exhibits antimicrobial activity with a log reduction of 1 or more, 2 or more, 3 or more, 4 or more, 5 or more, 6 or more, or 10 or more.

Also disclosed herein are crosslinked compositions comprising the compositions described herein crosslinked with a crosslinker. In some examples, the crosslinker comprises a vinylic crosslinker, difunctional isocyanate crosslinker, difunctional epoxide crosslinker, difunctional alkyl halide, difunctional anhydride, a bis-halo-alkylether derivative, an activated ester, or combination thereof. In some examples, the crosslinked composition is non-leaching. In some examples, the crosslinked composition exhibits antimicrobial activity. In some examples, the crosslinked composition exhibits antimicrobial activity with a log reduction of 1 or more, 2 or more, 3 or more, 4 or more, 5 or more, 6 or more, or 10 or more.

Also disclosed herein are interpenetrating polymer networks comprising any of the compositions described herein crosslinked with a crosslinker in the presence of an initiator, an additional monomer, a UV-blocker, a blue light blocker, a dye, a pigment, a solvent, an additional antimicrobial agent, or a combination thereof. In some examples, the crosslinker comprises a vinylic crosslinker, difunctional isocyanate crosslinker, difunctional epoxide crosslinker, difunctional alkyl halide, difunctional anhydride, a bis-halo-alkylether derivative, an activated ester, or combination thereof. In some examples, the interpenetrating polymer network is non-leaching. In some examples, the interpenetrating polymer network exhibits antimicrobial activity. In some examples, the interpenetrating polymer network exhibits antimicrobial activity with a log reduction of 1 or more, 2 or more, 3 or more, 4 or more, 5 or more, 6 or more, or 10 or more.

Also disclosed herein are methods of use of any of the compositions disclosed herein, any of the crosslinked compositions disclosed herein, any of the interpenetrating polymer networks disclosed herein, or a combination thereof, wherein the method comprises using the composition, the crosslinked composition, the interpenetrating polymer network, or combination thereof in a medical device. In some examples, the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof. In some examples, the medical device comprises an ophthalmic device. In some examples, the ophthalmic device comprises a contact lens, an intraocular lens, a corneal inlay, an eye bandage, a drug delivery device, a prosthetic device, or a combination thereof. In some examples, the composition, the crosslinked composition, the interpenetrating polymer network, or combination thereof is chemically bound to the medical device, such as to a surface of the medical device. In some examples, the composition, the crosslinked composition, the interpenetrating polymer network, or combination thereof is incorporated within the bulk of the medical device. In some examples, the composition, the crosslinked composition, the interpenetrating polymer network, or combination thereof is non-leaching. In some examples, the composition, the crosslinked composition, the interpenetrating polymer network, or combination thereof exhibits antimicrobial activity. In some examples, the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Also disclosed herein are methods of use of any of the compositions disclosed herein, any of the crosslinked compositions disclosed herein, any of the interpenetrating polymer networks disclosed herein, or a combination thereof, wherein the method comprises using the composition, the crosslinked composition, the interpenetrating polymer network, or combination thereof in an ophthalmic device. In some examples, the ophthalmic device comprises a contact lens, an intraocular lens, a corneal inlay, an eye bandage, a drug delivery device, a prosthetic device, or a combination thereof. In some examples, the composition, the crosslinked composition, the interpenetrating polymer network, or combination thereof is chemically bound to the ophthalmic device, such as to a surface of the ophthalmic device. In some examples, the composition, the crosslinked composition, the interpenetrating polymer network, or combination thereof is incorporated within the bulk of the ophthalmic device. In some examples, the composition, the crosslinked composition, the interpenetrating polymer network, or combination thereof is non-leaching. In some examples, the composition, the crosslinked composition, the interpenetrating polymer network, or combination thereof exhibits antimicrobial activity. In some examples, the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Also disclosed herein are methods of use of any of the compositions disclosed herein, any of the crosslinked compositions disclosed herein, any of the interpenetrating polymer networks disclosed herein, or a combination thereof, wherein the method comprises using the composition, the crosslinked composition, the interpenetrating polymer network, or combination thereof in as a coating for a medical device. In some examples, the coating is chemically bound to the medical device, such as to a surface of the medical device. In some examples, the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof. In some examples, the medical device comprises an ophthalmic device. In some examples, the ophthalmic device comprises a contact lens, an intraocular lens, a corneal inlay, an eye bandage, a drug delivery device, a prosthetic device, or a combination thereof. In some examples, the composition, the crosslinked composition, the interpenetrating polymer network, or combination thereof is non-leaching. In some examples, the composition, the crosslinked composition, the interpenetrating polymer network, or combination thereof exhibits antimicrobial activity. In some examples, the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Also disclosed herein are methods of use of any of the compositions disclosed herein, any of the crosslinked compositions disclosed herein, any of the interpenetrating polymer networks disclosed herein, or a combination thereof, wherein the method comprises using the composition, the crosslinked composition, the interpenetrating polymer network, or combination thereof as a wound dressing. In some examples, the wound dressing exhibits efficient mass transfer of oxygen, antimicrobial agents, antifungal agents, antiviral agents, fluids, gases, or a combination thereof. In some examples, the composition, the crosslinked composition, the interpenetrating polymer network, or combination thereof is chemically bound to the wound dressing, such as to a surface of the wound dressing. In some examples, the composition, the crosslinked composition, the interpenetrating polymer network, or combination thereof is incorporated within the bulk of the wound dressing. In some examples, the composition, the crosslinked composition, the interpenetrating polymer network, or combination thereof is non-leaching. In some examples, the composition, the crosslinked composition, the interpenetrating polymer network, or combination thereof exhibits antimicrobial activity. In some examples, the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Also disclosed herein are methods of treating, preventing, inhibiting, and/or ameliorating an infection in a subject, the method comprising using any of the compositions disclosed herein, any of the crosslinked compositions disclosed herein, any of the interpenetrating polymer networks disclosed herein, any of the medical devices disclosed herein, any of the ophthalmic devices disclosed herein, or any of the wound dressings disclosed herein in the subject.

Also disclosed herein are articles of manufacture comprising any of the compositions disclosed herein, any of the crosslinked compositions disclosed herein, any of the interpenetrating polymer networks disclosed herein, or a combination thereof. In some examples, the article of manufacture comprises a medical device. In some examples, the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof. In some examples, the article of manufacture comprises an ophthalmic device wherein the ophthalmic device comprises a contact lens, an intraocular lens, a corneal inlay, an eye bandage, a drug delivery device, a prosthetic device, or a combination thereof. In some examples, the article of manufacture comprises a contact lens. In some examples, the composition, the crosslinked composition, the interpenetrating polymer network, or combination thereof is non-leaching. In some examples, the composition, the crosslinked composition, the interpenetrating polymer network, or combination thereof exhibits antimicrobial activity. In some examples, the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Also disclosed herein are methods of treating, preventing, inhibiting, and/or ameliorating an infection in a subject, the method comprising using any of the articles described herein in the subject.

Also disclosed herein are contact lenses comprising any of the compositions disclosed herein, any of the crosslinked compositions disclosed herein, any of the interpenetrating polymer networks disclosed herein, or a combination thereof. In some examples, the composition, the crosslinked composition, the interpenetrating polymer network, or combination thereof is chemically bound to the contact lens, such as to a surface of the contact lens. In some examples, the composition, the crosslinked composition, the interpenetrating polymer network, or combination thereof is incorporated within the bulk of the contact lens. Also disclosed herein are contact lenses comprising a coating comprising any of the compositions disclosed herein, any of the crosslinked compositions disclosed herein, any of the interpenetrating polymer networks disclosed herein, or a combination thereof. In some examples, the coating is chemically bound to the contact lens, such as to a surface of the contact lens. In some examples, the contact lens comprises a soft, hydrophilic contact lens. In some examples, the contact lens is cosmetically tinted. In some examples, the contact lens is antimicrobial. In some examples, the contact lens is antifouling. In some examples, the composition, the crosslinked composition, the interpenetrating polymer network, or combination thereof is non-leaching. In some examples, the composition, the crosslinked composition, the interpenetrating polymer network, or combination thereof exhibits antimicrobial activity. In some examples, the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Also disclosed herein are methods of treating, preventing, inhibiting, and/or ameliorating an infection in a subject, the method comprising using any of the contact lenses disclosed herein in the subject.

Also disclosed herein are methods of making any of the compositions disclosed herein, any of the crosslinked compositions disclosed herein, any of the interpenetrating polymer networks disclosed herein, or a combination thereof.

Also disclosed herein are methods of making any of the crosslinked compositions disclosed herein, the method comprising crosslinking any of the compositions disclosed herein. In some examples, the method comprises mixing the composition with the crosslinker to form a mixture and crosslinking the mixture. In some examples, the crosslinking is performed with the aid of thermal energy, actinic radiation, or a combination thereof. In some examples, the crosslinking comprises thermal curing and/or UV-curing. In some examples, the mixture further comprises an initiator, an additional monomer, a UV-blocker, a blue light blocker, a dye, a pigment, a solvent, an additional antimicrobial agent, or a combination thereof. In some examples, the mixture further comprises an additional antimicrobial agent. In some examples, the additional antimicrobial agent comprises a quaternary ammonium compound, an antimicrobial metal, or a combination thereof. In some examples, the additional antimicrobial agent comprises a quaternary ammonium compound. In some examples, the additional antimicrobial agent comprises an antimicrobial metal comprising Ag, Au, Pt, Pd, Ir, Sn, Cu, Sb, Bi, or Zn. In some examples, the additional antimicrobial agent comprises a plurality of nanoparticles comprising the antimicrobial metal.

Also disclosed herein are methods of making any of the interpenetrating polymer networks disclosed herein, the methods comprising mixing any of the compositions disclosed herein with the crosslinker in the presence of the initiator, the additional monomer, the UV-blocker, the blue light blocker, the dye, the pigment, the solvent, the additional antimicrobial agent, or a combination thereof, to thereby form a mixture, and crosslinking the composition. In some examples, the crosslinking is performed with the aid of thermal energy, actinic radiation, or a combination thereof. In some examples, the crosslinking comprises thermal curing and/or

UV-curing. In some examples, the mixture comprises the additional antimicrobial agent. In some examples, the additional antimicrobial agent comprises a quaternary ammonium compound, an antimicrobial metal, or a combination thereof. In some examples, the additional antimicrobial agent comprises a quaternary ammonium compound. In some examples, the additional antimicrobial agent comprises an antimicrobial metal comprising Ag, Au, Pt, Pd, Ir, Sn, Cu, Sb, Bi, or Zn. In some examples, the additional antimicrobial agent comprises a plurality of nanoparticles comprising the antimicrobial metal.

Additional advantages of the disclosed compositions, devices, systems, and methods will be set forth in part in the description which follows, and in part will be obvious from the description. The advantages of the disclosed compositions, devices, systems, and methods will be realized and attained by means of the elements and combinations particularly pointed out in the appended claims. It is to be understood that both the foregoing general description and the following detailed description are exemplary and explanatory only and are not restrictive of the disclosed compositions, devices, systems, and methods, as claimed.

The details of one or more embodiments of the invention are set forth in the accompanying drawings and the description below. Other features, objects, and advantages of the invention will be apparent from the description and drawings, and from the claims.

### DETAILED DESCRIPTION

The compositions, devices, methods, and systems described herein may be understood more readily by reference to the following detailed description of specific aspects of the disclosed subject matter and the Examples included therein.

Before the present compositions, devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. As used in the specification and in the claims, the term “comprising” can include the aspects “consisting of” and “consisting essentially of.”

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

When the specific values are disclosed between two end values, it is understood that these end values can also be included.

For the terms “for example” and “such as,” and grammatical equivalences thereof, the phrase “and without limitation” is understood to follow unless explicitly stated otherwise. It is further understood that these phrases are not used in a restrictive sense, but for explanatory purposes. “Exemplary” means “an example of” and is not intended to convey an indication of a preferred or ideal embodiment.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “and/or” includes any and all combinations of one or more of the associated listed items.

As used herein, the term “substantially” means that the subsequently described event or circumstance completely occurs or that the subsequently described event or circumstance generally, typically, or approximately occurs.

Still further, the term “substantially” can, in some aspects, refer to at least 80%, at least 85%, at least 90%, at least 91%, at least 92%, at least 93%, at least 94%, at least 95%, at least 96%, at least 97%, at least 98%, at least 99%, or 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then 1% by weight, e.g., less than 0.5% by weight, less than 0.1% by weight, less than 0.05% by weight, or less than 0.01% by weight of the stated material, based on the total weight of the composition.

The expressions “ambient temperature” and “room temperature” as used herein are understood in the art and refer generally to a temperature from 20° C. to 35° C.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight of component Y, components X and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It is understood that the term “salt,” as used herein, refers to a chemical compound that can be formed form a reaction between an acid and a base. It is understood that the term “salt,” as used herein, encompasses both inorganic and organic salts capable of providing the desired properties to the composition. In still further aspects, a cation of the disclosed herein salts is a metal cation.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

Unless otherwise defined, all technical and scientific terms used herein have the same meaning as commonly understood by one of ordinary skill in the art to which this invention belongs.

As used herein, by a “subject” is meant an individual. Thus, the “subject” can include domesticated animals (e.g., cats, dogs, etc.), livestock (e.g., cattle, horses, pigs, sheep, goats, etc.), laboratory animals (e.g., mouse, rabbit, rat, guinea pig, etc.), and birds. “Subject” can also include a mammal, such as a primate or a human. Thus, the subject can be a human or veterinary patient. The term “patient” refers to a subject under the treatment of a clinician, e.g., physician.

“Biocompatible” and “biologically compatible”, as used herein, generally refer to compounds and/or compositions that are, along with any metabolites or degradation products thereof, generally non-toxic to normal cells and tissues, and which do not cause any significant adverse effects to normal cells and tissues when cells and tissues are incubated (e.g., cultured) in their presence.

The term “biodegradable” as used herein refers to a material or substance wherein physical dissolution and/or chemical degradation is effected under physiological conditions.

As used herein, “reduce” or other forms of the word, such as “reducing” or “reduction,” refers to lowering of an event or characteristic (e.g., microbe population/infection). It is understood that the reduction is typically in relation to some standard or expected value. For example, “reducing microbial infection” means reducing the spread of a microbial infection relative to a standard or a control.

As used herein, “prevent” or other forms of the word, such as “preventing” or “prevention,” refers to stopping a particular event or characteristic, stabilizing or delaying the development or progression of a particular event or characteristic, or minimizing the chances that a particular event or characteristic will occur. “Prevent” does not require comparison to a control as it is typically more absolute than, for example, “reduce.” As used herein, something could be reduced but not prevented, but something that is reduced could also be prevented. Likewise, something could be prevented but not reduced, but something that is prevented could also be reduced.

As used herein, “treat” or other forms of the word, such as “treated” or “treatment,” refers to administration of a composition or performing a method in order to reduce, prevent, inhibit, or eliminate a particular characteristic or event (e.g., microbe growth or survival). The term “control” is used synonymously with the term “treat.”

The term “therapeutically effective” refers to the amount of the composition used is of sufficient quantity to ameliorate one or more causes or symptoms of a disease or disorder. Such amelioration only requires a reduction or alteration, not necessarily elimination.

The term “pharmaceutically acceptable” refers to those compounds, materials, compositions, and/or dosage forms which are, within the scope of sound medical judgment, suitable for use in contact with the tissues of human beings and animals without excessive toxicity, irritation, allergic response, or other problems or complications commensurate with a reasonable benefit/risk ratio.

An “ophthalmic device”, as used herein, refers to any of the following: a contact lens (hard or soft), an intraocular lens, a corneal inlay, glaucoma shunt, an eye bandage, a drug delivery device, a prosthetic device, or ophthalmic stent used on or about a subject's eye or ocular vicinity.

“Contact Lens” refers to a structure that can be placed on or within a subject's eye. A contact lens can correct, improve, or alter a subject's eyesight. However, a contact lens may also be used as an eye bandage, drug delivery device, and prosthetic device. In the case of color contact lenses, the device may be used to alter or enhance a subject's eye color, or to mask a subject's disfigured eyes. A contact lens can be of any appropriate material, and can be a soft lens, a hard lens, or a hybrid lens.

A “silicone hydrogel contact lens” refers to a contact lens comprising a silicone hydrogel material.

As used herein, “actinically” in reference to curing, crosslinking, or polymerizing of a polymerizable composition, a prepolymer, or a material means that the curing (e.g., crosslinking and/or polymerizing) is performed by actinic irradiation, such as, for example, UV light, visible light, ionized radiation (e.g., gamma ray or X-ray irradiation), microwave radiation, and the like. Thermal curing or actinic curing methods are well-known in the art.

A “photo-initiator” refers to a chemical that initiates radical crosslinking/polymerizing reaction by the use of light.

A “thermal initiator” refers to a chemical that initiates free radical polymerization and/or crosslinking reactions using heat energy.

The term “fluid” as used herein indicates that a material is capable of flowing like a liquid. Fluids include, for example, liquids, gases, supercritical fluids, etc.

The term “biological materials” includes, for example, cells, yeasts, bacteria, proteins, peptides, cytokines, and hormones. Cells include progenitor cells (e.g., endothelial progenitor cells), stem cells (e.g., mesenchymal, hematopoietic, neuronal), stromal cells, parenchymal cells, undifferentiated cells, fibroblasts, macrophage, and satellite cells.

Epithelial tissue covers or lines all body surfaces inside or outside the body of a subject. Examples of epithelial tissue include, but are not limited to, the skin, epithelium, dermis, and the mucosa and serosa that line the body cavity and internal organs (such as the heart, lung, liver, kidney, intestines, bladder, uterus, etc.).

Connective tissue is the most abundant and widely distributed of all tissues. Examples of connective tissue include, but are not limited to, vascular tissue (e.g., arteries, veins, and capillaries), blood (e.g., red blood cells, platelets, and white blood cells), lymph, fat, fibers, cartilage, ligaments, tendon, bone, teeth, omentum, peritoneum, mesentery, meniscus, conjunctiva, dura mater, umbilical cord, etc.

Muscle tissue accounts for nearly one-third of the total body weight of a human subject. There are three distinct subtypes of muscle tissue: striated (skeletal) muscle, smooth (visceral) muscle, and cardiac muscle. Examples of muscle tissue include, but are not limited to, myocardium (heart muscle), skeletal, intestinal wall, etc.

The fourth primary type of tissue is nerve tissue. Nerve tissue is found in the brain, spinal cord, and accompanying nerves. Nerve tissue is composed of specialized cells called neurons (nerve cells) and neuroglial or glial cells.

“Anti-thrombotic” as used herein refers to a medical device that has reduced ability to cause a blood clot and/or a reduced rated of clotting, as compared to an untreated medical device. It will be appreciated that the reduced clotting associated with the device is not to be limited to clots that form within the device, but also includes other clots associated with the use of the device.

Handling tint in reference to a contact lens means a lightly tinted contact lens. This is accomplished by dying (or coloring) of a lens to enable the subject to easily locate a contact lens in a clear solution within a lens storage container, disinfecting container, or cleaning container. A dye and/or a pigment can be used in visibility tinting of a contact lens.

“Dye” means a substance that is soluble in a solvent and that is used to impart color. Dyes are typically translucent and absorb but do not scatter light. Any suitable biocompatible dye can be used in the present invention.

A “pigment” refers to a powdered substance that is suspended in a liquid in which it is insoluble. A pigment can be a conventional pigment, fluorescent pigment, phosphorescent pigment, or pearlescent pigment. Any suitable pigment may be employed. In some examples, the pigment is heat resistant, non-toxic, and insoluble in aqueous solutions.

“Surface modification”, as used herein, means that an article has been treated in a surface treatment process (or a surface modification process) prior to or posterior to the formation of the article, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Exemplary surface treatment processes include, but are not limited to, corona, UV-ozone, and plasma processes in which an ionized gas is applied to the surface of an article (see, for example, U.S. Pat. Nos. 4,312,575 and 4,632,844); a surface treatment by energy other than plasma (e.g., a static electrical charge, irradiation, or other energy source); chemical treatments; the grafting of hydrophilic monomers or macromers onto the surface of an article; mold-transfer coating processes such as those described in U.S. Pat. No. 6,719,929; the incorporation of wetting agents into a lens formulation for making contact lenses (i.e., surface treatment prior to polymerization), such as those described in U.S. Pat. Nos. 4,045,547, 4,042,552, 5,198,477, 5,219,965, 6,367,929, 6,822,016, and 7,279,507; and layer-by-layer coating (“LBL coating”) obtained, for example according to methods described in U.S. Pat. Nos. 6,451,871, 6,719,929, 6,793,973, 6,811,805, and 6,896,926.

“Post-curing surface treatment,” as used herein in reference to a silicone hydrogel material or a soft contact lens, means a surface treatment process that is performed after the formation (curing) of the hydrogel material or the soft contact lens in a mold.

A “hydrophilic surface,” as used herein in reference to a silicone hydrogel material or a contact lens, means that the silicone hydrogel material or the contact lens has a surface hydrophilicity characterized by having an average water contact angle of 90 degrees or less (e.g., 80 degrees or less, 70 degrees or less, 60 degrees or less, 50 degrees or less, 40 degrees or less, 30 degrees or less, 20 degrees or less, or 10 degrees or less). Contact angle can be measured by a sessile drop method using advancing angle or using a captive bubble method. The average contact angle using sessile drop method refers to a water contact angle obtained by averaging the measurements of at least 3 individual contact lenses. The captive bubble (sessile bubble) method is a special arrangement for measuring the contact angle between a liquid and a solid using drop shape analysis. Instead of placing a drop on the solid as in the case of the sessile drop, a bubble of air is injected beneath a solid, the surface of which is located in the liquid. Unless otherwise noted, contact angles for materials of the present invention correspond to a captive bubble contact angle measurement.

As used herein, “antimicrobial” refers to the ability to treat or control (e.g., reduce, prevent, treat, or eliminate) the growth of a microbe at any concentration. Similarly, the terms “antibacterial,” “antifungal,” and “antiviral” refer to the ability to treat or control the growth of bacteria, fungi, and viruses at any concentration, respectively.

An “antimicrobial agent”, as used herein, refers to an agent that is capable of decreasing, eliminating, or inhibiting the growth of microorganisms.

“Antimicrobial compound” as used herein, refers to organic compounds with functional groups known for antimicrobial activity. Functional groups known for antimicrobial activity include, but are not limited to, quaternary ammonium, chalcones, quinolones, phenolics, polyphenols, phenolic acids, quinones, saponins, flavonoids, tannins, coumarins, terpenoids, alkaloids. Example antimicrobial compounds include, but are not limited to, substituted polycationic polysiloxane cationic anthraquinone-based dye and Poly(hexamethylenebiguanide) hydrochloride.

“Antimicrobial metals” are metals whose ions have an antimicrobial effect and which are biocompatible. In some examples, the antimicrobial metal comprises Ag, Au, Pt, Pd, Ir, Sn, Cu, Sb, Bi, or Zn. In some examples, the antimicrobial metal comprises Ag.

“Antimicrobial metal-containing nanoparticles” refer to particles having a size of less than 1 micrometer and containing at least one antimicrobial metal present in one or more of its oxidation states. “Antimicrobial metal nanoparticles” refer to particles which consist essentially of an antimicrobial metal and have a size of less than 1 micrometer. The antimicrobial metal in the antimicrobial metal nanoparticles can be present in one or more of its oxidation states. For example, silver-containing nanoparticles can contain silver in one or more of its oxidation states, such as Ag⁰, Ag¹⁺, and Ag²⁺.

### Chemical Definitions

Unless otherwise defined, all technical and scientific terms used herein have the same meaning as commonly understood by one of ordinary skill in the art to which this invention belongs.

The organic moieties mentioned when defining variable positions within the general formulae described herein (e.g., the term “halogen”) are collective terms for the individual substituents encompassed by the organic moiety. The prefix Cn-Cm preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹.” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

As used herein, the term “alkyl” refers to saturated, straight-chained or branched saturated hydrocarbon moieties. Unless otherwise specified, C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄)alkyl groups are intended. Examples of alkyl groups include methyl, ethyl, propyl, 1-methyl-ethyl, butyl, 1-methyl-propyl, 2-methyl-propyl, 1,1-dimethyl-ethyl, pentyl, 1-methyl-butyl, 2-methyl-butyl, 3-methyl-butyl, 2,2-dimethyl-propyl, 1-ethyl-propyl, hexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, 1-ethyl-2-methyl-propyl, heptyl, octyl, nonyl, decyl, dodecyl, tetradecyl, hexadecyl, eicosyl, tetracosyl, and the like. Alkyl substituents may be unsubstituted or substituted with one or more chemical moieties. The alkyl group can be substituted with one or more groups including, but not limited to, hydroxyl, halogen, acyl, alkyl, alkoxy, alkenyl, alkynyl, aryl, heteroaryl, aldehyde, amino, cyano, carboxylic acid, ester, ether, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides (halogens; e.g., fluorine, chlorine, bromine, or iodine). The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

As used herein, the term “alkenyl” refers to unsaturated, straight-chained, or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄)alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure —CH═CH—CH₃; and 2-propenyl refers to a group with the structure —CH₂—CH═CH₂. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. Alkenyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below, provided that the substituents are sterically compatible and the rules of chemical bonding and strain energy are satisfied.

As used herein, the term “alkynyl” represents straight-chained or branched hydrocarbon moieties containing a triple bond. Unless otherwise specified, C₂-C₂₄ (e.g., C₂-C₂₄, C₂-C₂₀, C₂-C₁₈, C₂-C₁₆, C₂-C₁₄, C₂-C₁₂, C₂-C₁₀, C₂-C₈, C₂-C₆, or C₂-C₄)alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl. Alkynyl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol, as described below.

As used herein, the term “aryl,” as well as derivative terms such as aryloxy, refers to groups that include a monovalent aromatic carbocyclic group of from 3 to 50 carbon atoms. Aryl groups can include a single ring or multiple condensed rings. In some examples, aryl groups include C₆-C₁₀ aryl groups. Examples of aryl groups include, but are not limited to, benzene, phenyl, biphenyl, naphthyl, tetrahydronaphthyl, phenylcyclopropyl, phenoxybenzene, and indanyl. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is also included in the term “aryl,” defines a group that contains an aromatic group that does not contain a heteroatom. The aryl substituents may be unsubstituted or substituted with one or more chemical moieties. Examples of suitable substituents include, for example, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, acyl, aldehyde, amino, cyano, carboxylic acid, ester, ether, halide, hydroxyl, ketone, nitro, phosphonyl, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems (e.g., monocyclic, bicyclic, tricyclic, polycyclic, etc.) that can be substituted or unsubstituted. A cyclic group can contain one or more aryl groups, one or more non-aryl groups, or one or more aryl groups and one or more non-aryl groups.

The term “acyl” as used herein is represented by the formula —C(O)Z¹ where Z¹ can be a hydrogen, hydroxyl, alkoxy, alkyl, alkenyl, alkynyl, aryl, heteroaryl, cycloalkyl, cycloalkenyl, heterocycloalkyl, or heterocycloalkenyl group described above. As used herein, the term “acyl” can be used interchangeably with “carbonyl.” Throughout this specification “C(O)” or “CO” is a shorthand notation for C═O.

The term “acetal” as used herein is represented by the formula (Z¹Z²) C(═OZ³) (═OZ⁴), where Z¹, Z², Z³, and Z⁴ can be, independently, a hydrogen, halogen, hydroxyl, alkyl, alkenyl, alkynyl, aryl, heteroaryl, cycloalkyl, cycloalkenyl, heterocycloalkyl, or heterocycloalkenyl group described above.

The term “alkanol” as used herein is represented by the formula Z¹OH, where Z¹ can be an alkyl, alkenyl, alkynyl, aryl, heteroaryl, cycloalkyl, cycloalkenyl, heterocycloalkyl, or heterocycloalkenyl group described above.

As used herein, the term “alkoxy” as used herein is an alkyl group bound through a single, terminal ether linkage; that is, an “alkoxy” group can be defined as to a group of the formula Z¹—O—, where Z¹ is unsubstituted or substituted alkyl as defined above. Unless otherwise specified, alkoxy groups wherein Z¹ is a C₁-C₂₄ (e.g., C₁-C₂₂, C₁-C₂₀, C₁-C₁₈, C₁-C₁₆, C₁-C₁₄, C₁-C₁₂, C₁-C₁₀, C₁-C₈, C₁-C₆, or C₁-C₄)alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-di-methyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

The term “aldehyde” as used herein is represented by the formula —C(O) H. Throughout this specification “C(O)” is a shorthand notation for C═O.

The term “amino” as used herein are represented by the formula —NZ¹Z²Z³, where Z¹, Z², and Z³ can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The terms “amide” or “amido” as used herein are represented by the formula —C(O)NZ¹Z², where Z¹ and Z² can each be substitution group as described herein, such as hydrogen, an alkyl, alkenyl, alkynyl, aryl, heteroaryl, cycloalkyl, cycloalkenyl, heterocycloalkyl, or heterocycloalkenyl group described above.

The term “anhydride” as used herein is represented by the formula Z¹C(O)OC(O)Z² where Z¹ and Z², independently, can be an alkyl, alkenyl, alkynyl, aryl, heteroaryl, cycloalkyl, cycloalkenyl, heterocycloalkyl, or heterocycloalkenyl group described above.

The term “cyclic anhydride” as used herein is represented by the formula:

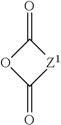

where Z¹ can be an alkyl, alkenyl, alkynyl, aryl, heteroaryl, cycloalkyl, cycloalkenyl, heterocycloalkyl, or heterocycloalkenyl group described above.

The term “azide” as used herein is represented by the formula —N═N═N.

The term “carboxylic acid” as used herein is represented by the formula —C(O) OH.

A “carboxylate” or “carboxyl” group as used herein is represented by the formula —C(O)O⁻.

The term “cyano” as used herein is represented by the formula —CN.

The term “ester” as used herein is represented by the formula —OC(O)Z¹ or —C(O) OZ¹, where Z¹ can be an alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “epoxy” or “epoxide” as used herein refers to a cyclic ether with a three atom ring and can represented by the formula:

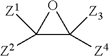

where Z¹, Z², Z³, and Z⁴ can be, independently, an alkyl, alkenyl, alkynyl, aryl, heteroaryl, cycloalkyl, cycloalkenyl, heterocycloalkyl, or heterocycloalkenyl group described above

The term “ketone” as used herein is represented by the formula Z¹C(O)Z², where Z¹ and Z² can be, independently, an alkyl, alkenyl, alkynyl, aryl, heteroaryl, cycloalkyl, cycloalkenyl, heterocycloalkyl, or heterocycloalkenyl group described above.

The term “halide” or “halogen” or “halo” as used herein refers to fluorine, chlorine, bromine, and iodine.

The term “hydroxyl” as used herein is represented by the formula —OH.

The term “nitro” as used herein is represented by the formula —NO₂.

The term “perfluoro” is used herein as a prefix to indicate most or all C—H bonds in the compound following the prefix have been replaced by C—F bonds, as allowed under steric and stability constraints.

The term “phosphonyl” is used herein to refer to the phospho-oxo group represented by the formula —P(O)(OZ¹)₂, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “silyl” as used herein is represented by the formula —SiZ¹Z²Z³, where Z¹, Z², and Z³ can be, independently, hydrogen, alkyl, alkoxy, alkenyl, alkynyl, aryl, heteroaryl, cycloalkyl, cycloalkenyl, heterocycloalkyl, or heterocycloalkenyl group described above.

The term “sulfonyl” or “sulfone” is used herein to refer to the sulfo-oxo group represented by the formula —S(O)₂Z¹, where Z¹ can be hydrogen, an alkyl, alkenyl, alkynyl, aryl, heteroaryl, cycloalkyl, cycloalkenyl, heterocycloalkyl, or heterocycloalkenyl group described above.

The term “sulfide” as used herein comprises the formula —S—.

The term “thiol” as used herein is represented by the formula —SH.

“R¹,” “R²,” “R³,” “Rⁿ,” etc., where n is some integer, as used herein can, independently, possess one or more of the groups listed above. For example, if R¹ is a straight chain alkyl group, one of the hydrogen atoms of the alkyl group can optionally be substituted with a hydroxyl group, an alkoxy group, an amino group, an alkyl group, a halide, and the like. Depending upon the groups that are selected, a first group can be incorporated within a second group or, alternatively, the first group can be pendant (i.e., attached) to the second group. For example, with the phrase “an alkyl group comprising an amino group,” the amino group can be incorporated within the backbone of the alkyl group. Alternatively, the amino group can be attached to the backbone of the alkyl group. The nature of the group(s) that is (are) selected will determine if the first group is embedded or attached to the second group.

Unless stated to the contrary, a formula with chemical bonds shown only as solid lines and not as wedges or dashed lines contemplates each possible stereoisomer or mixture of stereoisomer (e.g., each enantiomer, each diastereomer, each meso compound, a racemic mixture, or scalemic mixture).

“Hydrophilic,” as used herein, describes a material or portion thereof that has the characteristics of readily absorbing or dissolving in water, having polar groups (distribution of electrons is uneven, enabling it to take part in electrostatic interactions) that readily interact with water, and/or having an affinity for water.

As used herein, the term “hydrophobic” refers to the characteristics of not readily absorbing or dissolving in water, being adversely affected by water, and/or having little or no affinity for water.

As used herein, the term “amphiphilic” refers to the characteristics of having both hydrophilic and hydrophobic properties.

A “hydrogel” or “hydrogel material” refers to a polymeric material which can absorb 10% by weight of water or more when it is fully hydrated (e.g., 15% or more, 20% or more, 25% or more, 30% or more, 40% or more, 50% or more, 60% or more, 70% or more, 80% or more, or 90% or more).

A “silicone hydrogel” refers to a siloxane or silicone-containing hydrogel obtained by copolymerization of a polymerizable composition comprising at least one silicone-containing monomer, at least one silicone-containing macromer, or at least one crosslinkable silicone-containing prepolymer.

A “vinylic monomer” means a low molecular weight compound having one ethylenically unsaturated group. Low molecular weight typically means average molecular weights less than 600 Daltons. Vinyl group as described here includes, but is not limited to, the following functional groups: alkene, (meth)acrylate, (meth)acrylamide, and styrenic functionality.

The term “olefinically unsaturated group” or “ethylenically unsaturated group” is employed herein in a broad sense and is intended to encompass any groups containing a carbon-carbon double bonded group (>C═C<group). Exemplary ethylenically unsaturated groups include, but are not limited to, (meth)acrylamide, (meth)acryloyl, allyl, vinyl, styrenyl, or other >C═C<containing groups.

“Polymer” means a material formed by polymerizing one or more monomers.

The term “(co) polymer” includes homopolymers, copolymers, or mixtures thereof.

The term “(meth)acryl . . . ” includes “acryl . . . ,” “methacryl . . . ,” or mixtures thereof.

The term “block copolymer” as used herein is a copolymer comprised of two or more homopolymer subunits linked by covalent bonds. The joining of the homopolymer subunits may require an intermediate non-repeating subunit, known as a junction block. Block copolymers with two or three distinct blocks are called di-block copolymers and tri-block copolymers, respectively. A block is a portion of a macromolecule, comprising many constitutional units, that has at least one feature which is not present in the adjacent portions.

The term prepolymer is used herein to refer to a polymer that has reactive groups that are available for bond forming reactions that will crosslink (intermolecular and/or intramolecular crosslink). It is not meant to imply that the prepolymer is not yet a polymer (e.g., a monomer or polymer precursor). Rather, a “prepolymer” refers to a starting polymer which contains multiple actinically crosslinkable groups and can be cured (e.g., crosslinked) actinically to obtain a crosslinked polymer having a molecular weight higher than the starting polymer.

A “macromer” refers to a medium and high molecular weight compound which can be polymerized and/or crosslinked actinically. Medium and high molecular weight typically means average molecular weights greater than 600 Daltons. For example, a macromer can be a macromer with one or more ethylenically unsaturated groups. A “siloxane-containing macromer” is a macromer which contains silicone and can be crosslinked actinically or with heat.

As used herein, “molecular weight” refers to number-average molecular weight as measured by 1H NMR spectroscopy, unless clearly indicated otherwise.

### Compositions and Antimicrobial Copolymers

Disclosed herein are antimicrobial copolymers and methods of making and use thereof.

For example, described herein is the development and application of antimicrobial copolymer coatings for medical devices, such as contact lenses, aimed at reducing microbial adhesion and preventing infections associated with their use. The copolymer, based on polydiallydimethyl ammonium chloride, can be chemically bonded to the device (e.g., lens) surface to ensure non-leaching antimicrobial activity.

Described herein are non-leaching polymer-based antimicrobial compositions suitable for medical devices, particularly contact lenses. These devices are susceptible to microbial colonization, leading to potential infections, highlighting the need for effective antimicrobial strategies. Medical devices of interest include but are not limited to contact lenses, intraocular lenses, wound dressings, sutures, catheters, endoscopes, ventilator tubes, intravenous lines, and stents.

The antimicrobial compositions described herein are copolymers of ammonium chloride. In some examples, copolymers of diallyldimethyl ammonium chloride described herein can be coated onto the surface of a medical device and then immobilized on the medical device through chemical reactions with or on the medical device surface. In some examples, the antimicrobial copolymers can be incorporated into bulk compositions of medical devices through polymerization reactions. Non-leaching devices are often considered preferable than leaching devices because microbes are exposed to high surface concentrations of the antimicrobial agent compared with slow-release. Moreover, leaching antimicrobial agents can be cytotoxic. Therefore, there remains a need for non-leaching, antimicrobial materials that exhibit antimicrobial activity and that can easily be adapted to high volume manufacturing.

Contact lenses are prone to microbial adherence and colonization, posing risks of eye infections. According to the CDC, eye infections are often associated with contact lens use, and up to 1 in 500 contact lens users experience a serious eye infection that can lead to blindness each year. A contact lens with antimicrobial properties has the potential to drastically reduce contact lens related eye infections.

Contact lenses are often exposed to pathogens during wear, storage and handling. They can provide surfaces onto which the microorganisms adhere and then proliferate to form a colony. Microbial adherence to and colonization of contact lenses may enable microorganisms to proliferate and to be retained on the ocular surface for prolonged periods and thereby may cause infection of the eye in which the lens is used. Therefore, there is a need to make various efforts to minimize and/or eliminate the potential for microorganism adhesion to and colonization of contact lenses.

Many attempts have been made to develop antimicrobial contact lenses, such as, for example, Chalkley et al.'s publication in Am. J. Ophthalmology 1966, 61:866-869 (contact lenses with germicidal agents incorporated therein); U.S. Pat. No. 4,472,327 (contact lenses with antimicrobial agents which may be added to the monomer before polymerization and locked into the polymeric structure of the lenses); U.S. Pat. Nos. 5,358,688 and 5,536,861 and European patent application EP0604369 (contact lenses containing quaternary ammonium group containing organosilicone polymers); European patent application EP0947856A2 (contact lenses containing a quaternary phosphonium group-containing polymer); U.S. Pat. No. 5,515,117 (contact lenses comprising polymeric materials and antimicrobial compounds); U.S. Pat. No. 5,213,801 (contact lenses including an antimicrobial ceramics containing at least one metal selected from Ag, Cu and Zn); U.S. Pat. No. 5,328,954 (contact lenses with coatings composed of a wide variety of antimicrobial agents.

WO2002/062402 discloses optically clear antimicrobial lens, containing greater than 0.01 weight percent activated silver as well as a method for the manufacture of such lens. U.S. patent application publication No. 2005/0013842A1 discloses that silver nanoparticles (Ag-nanoparticles) can be incorporated in extended-wear contact lenses to impart to the contact lenses an effective antimicrobial capability over a long period of time. US 2007/003603 discloses a method for making antimicrobial silver compositions comprising silver nanoparticles formed in situ. Said compositions comprise at least one stabilizing agent, one or more silver compounds, at least one reducing agent and a solvent. Although Ag-nanoparticles can be incorporated into contact lenses to impart antimicrobial properties, there are still some issues associated with silver. For example, the incorporation of Ag nanoparticles can impart contact lenses with undesirable yellowish color. Another problem with contact lenses containing silver nanoparticles is the unknown impact of silver nanoparticles on human health.

In spite of the forgoing efforts, there is not a commercially viable antimicrobial contact lenses, especially extended-wear contact lenses, which require antimicrobial activities over a long period of time.

For example, disclosed herein are compositions comprising an antimicrobial copolymer derived from diallyldimethyl ammonium chloride (DADMAC), wherein the antimicrobial copolymer comprises a curable or reactive group (e.g., one or more curable or reactive groups), for example that allows for post-polymerization curing, and the curable or reactive group is thermally and/or actinically curable.

In some examples, the antimicrobial copolymer is derived from diallyldimethyl ammonium chloride (DADMAC) and a curable monomer (e.g., one or more curable monomers), said curable monomer comprising said curable or reactive group. In some examples, the antimicrobial copolymer is derived from polymerization of diallyldimethyl ammonium chloride (DADMAC) and said curable monomer (e.g., one or more curable monomers).

In some examples, the antimicrobial copolymer derived from diallyldimethyl ammonium chloride (DADMAC) and a bifunctional vinylic monomer (e.g., one or more bifunctional vinylic monomers), the bifunctional vinylic monomer comprising said curable or reactive group. In some examples, the antimicrobial copolymer is derived from polymerization of DADMAC and the one or more bifunctional vinylic monomers.

In some examples, the curable or reactive group comprises an ethylenically unsaturated group, a hydroxyl group, an amino group, an epoxy group, a thiol group, or a combination thereof.

In some examples, the curable or reactive group comprises an ethylenically unsaturated group.

In some examples, the ethylenically unsaturated group comprises acryloyl, acrylamide, alkyl acrylamide, dialkyl acrylamide, methacryloyl, allyl, vinyl, styrenyl, or a combination thereof.

In some examples, the antimicrobial copolymer is defined by Formula I:

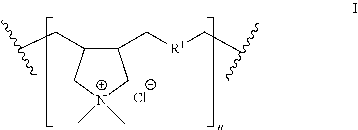

wherein R¹ comprises the curable or reactive group; and n is an integer from 1 to 10,000.

In some examples for Formula I, n is an integer from 50 to 10,000. In some examples for Formula I, n is an integer from 100 to 10,000.

In some examples of Formula I, R¹ is derived from the curable monomer. In some examples of Formula I, R¹ is derived from the bifunctional vinylic monomer.

In some examples, the antimicrobial copolymer is defined by Formula II:

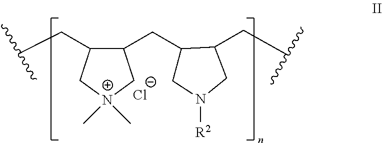

wherein R² comprises the curable or reactive group; and n is an integer from 1 to 10,000. In some examples of Formula II, n is an integer from 50 to 10,000. In some examples of Formula II, n is an integer from 100 to 10,000.

In some examples of Formula II, R² is selected from the group consisting of:

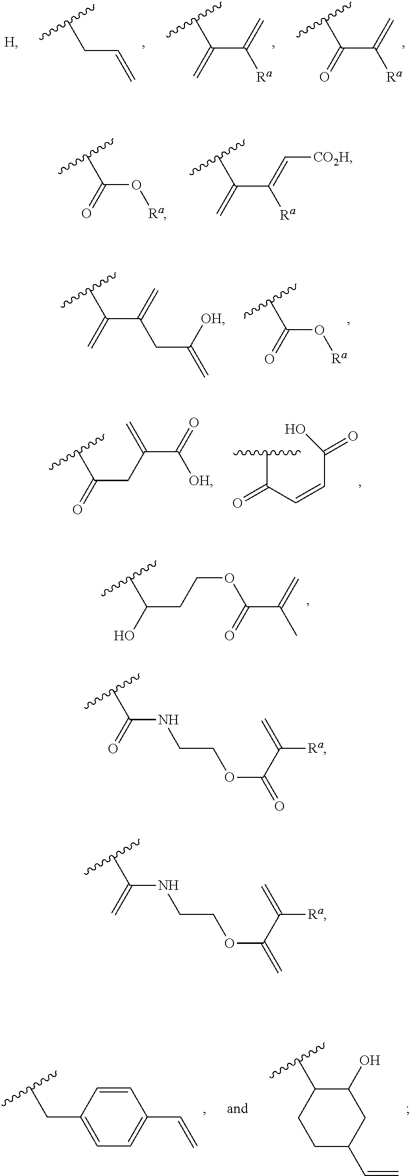

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples, the antimicrobial copolymer comprises a first curable or reactive group and a second curable or reactive group, each of which is thermally and/or actinically curable.

In some examples, the curable monomer comprises a first curable monomer with a first curable or reactive group and a second curable monomer with a second curable or reactive group, such that the antimicrobial copolymer comprises the first curable or reactive group and the second curable or reactive group, each of which is thermally and/or actinically curable.

In some examples, the bifunctional vinylic monomer comprises a first bifunctional vinylic monomer with a first curable or reactive group and a second bifunctional vinylic monomer with a second curable or reactive group, such that the antimicrobial copolymer comprises the first curable or reactive group and the second curable or reactive group, each of which is thermally and/or actinically curable.

In some examples, the first curable or reactive group and/or the second curable or reactive group each independently comprises an ethylenically unsaturated group, a hydroxyl group, an amino group, an epoxy group, a thiol group, or a combination thereof. In some examples, the first curable or reactive group and/or the second curable or reactive group independently comprises an ethylenically unsaturated group. In some examples, the first curable or reactive group and/or the second curable or reactive group independently comprises an ethylenically unsaturated group comprising acryloyl, acrylamide, alkyl acrylamide, dialkyl acrylamide, methacryloyl, allyl, vinyl, styrenyl, or a combination thereof.

In some examples, the antimicrobial copolymer is defined by Formula III:

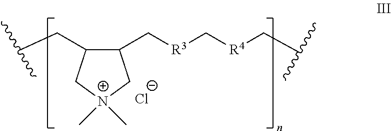

wherein R³ comprises the first curable or reactive group; R⁴ comprises the second curable or reactive group; and n is an integer from 1 to 10,000. In some examples of Formula III, n is an integer from 50 to 10,000. In some examples of Formula III, n is an integer from 100 to 10,000.

In some examples of Formula III, R³ and/or R⁴ are independently selected from the group consisting of:

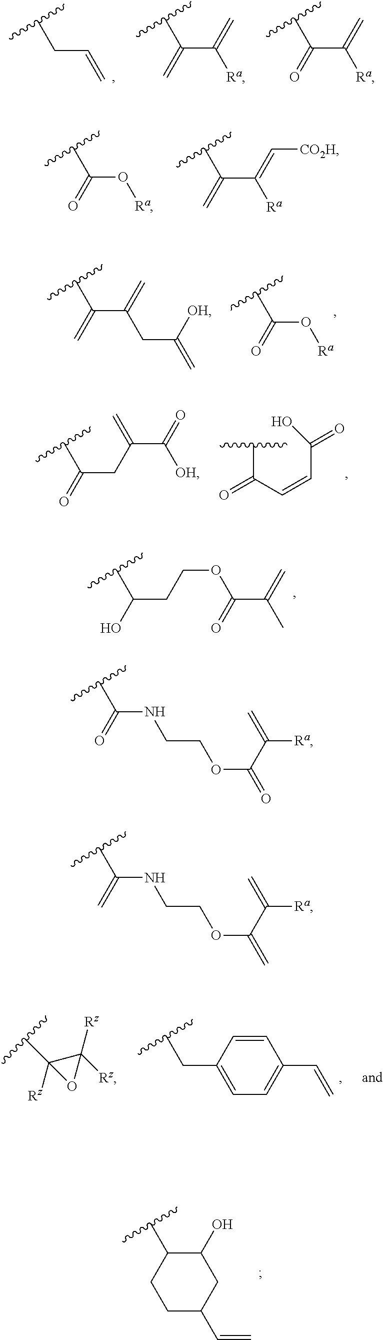

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof, and
R^{x} and R^{y} are independently H, OH, alkyl, alkenyl, alkynyl, cycloalkyl, aryl, alkylaryl, or heteroaryl.

In some examples, the antimicrobial copolymer is defined by Formula IV:

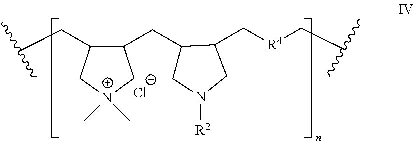

wherein R² comprises the first curable or reactive group; R⁴ comprises the second curable or reactive group; and n is an integer from 1 to 10,000. In some examples of Formula IV, n is an integer from 100 to 10,000. In some examples of Formula IV, n is an integer from 50 to 10,000.

In some examples of Formula IV, R² is selected from the group consisting of:

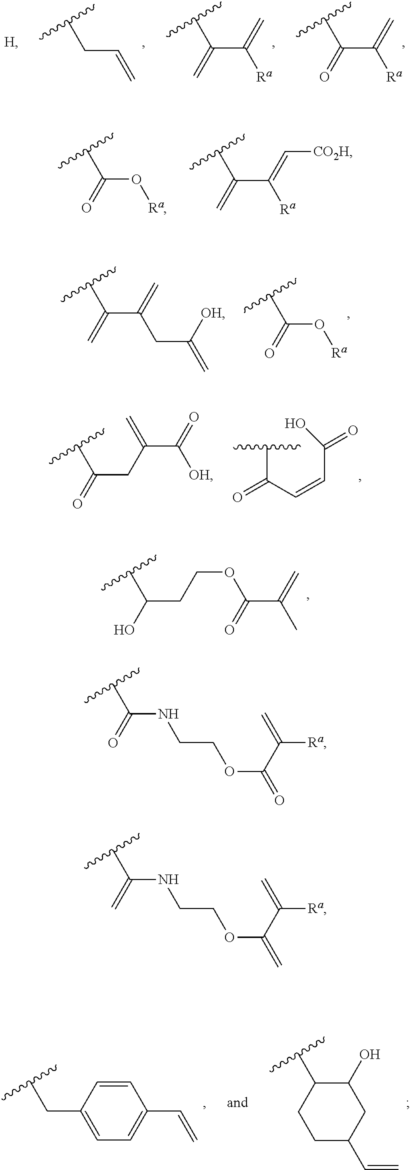

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples of Formula IV, R⁴ is selected from the group consisting of:

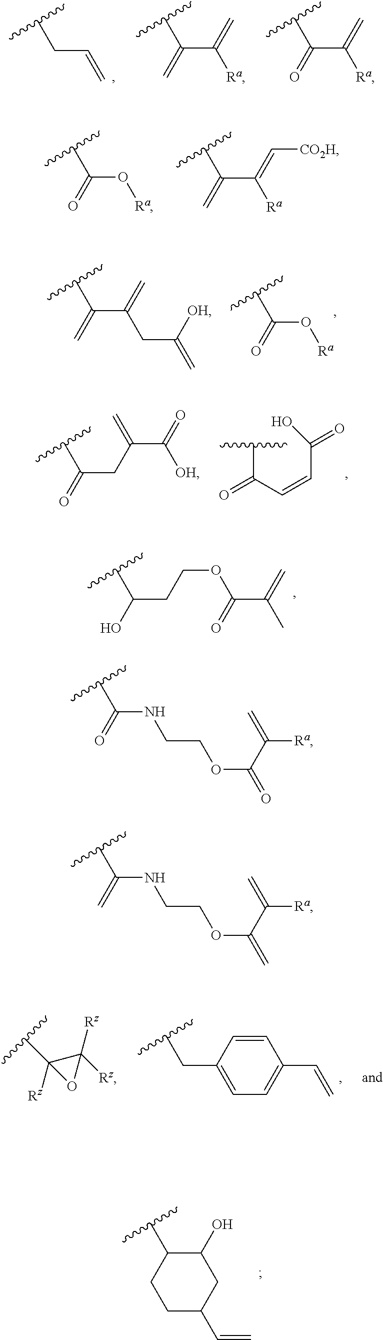

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

In some examples, the antimicrobial copolymer comprises:

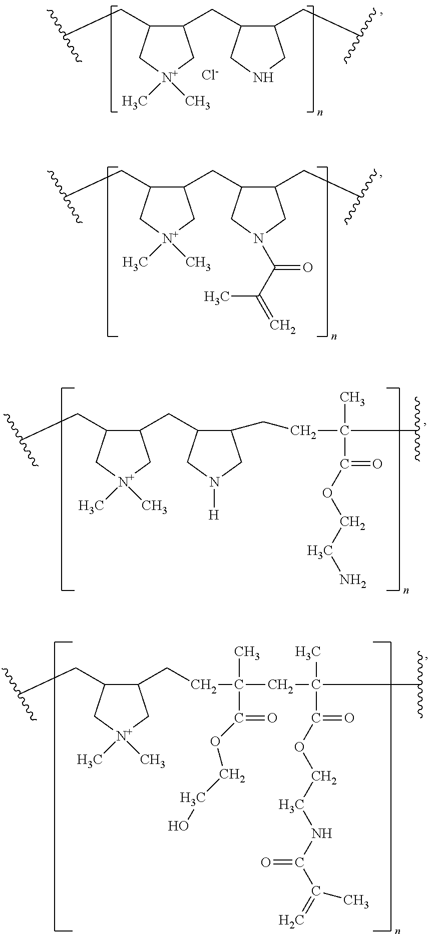

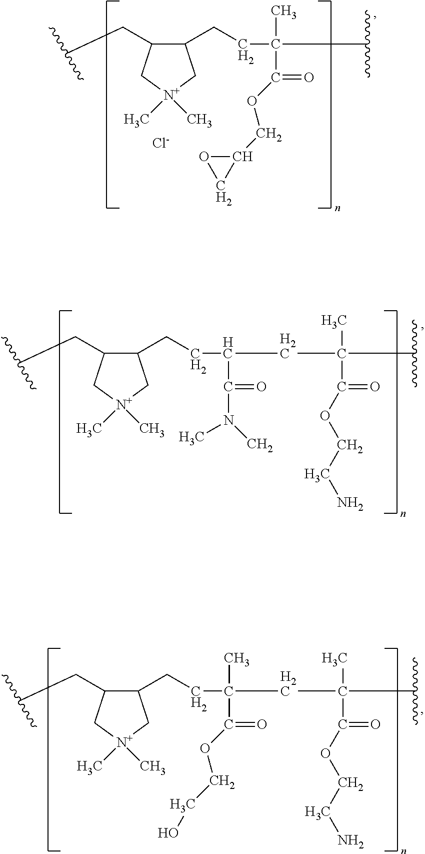

or a combination thereof, wherein each n is independently from 1 to 10,000.

In some examples, the antimicrobial copolymer is further derived from an additional monomer. In some examples, the antimicrobial copolymer is further derived from an additional monomer, wherein the additional monomer comprises a hydrophilic monomer, a hydrophobic monomer, an amphiphilic monomer, a zwitterionic monomer, a macromonomer, an antimicrobial monomer, or a combination thereof.

Suitable hydrophilic monomers comprise, for example, hydroxyl-substituted lower alkyl (C₁ to C₈) (meth)acrylates, (meth)acrylamide, (lower allyl) (meth)acrylamides, ethoxylated (meth)acrylates, hydroxyl-substituted (lower alkyl) (meth)acrylamides, hydroxyl-substituted lower alkyl vinyl ethers, sodium vinyl sulfonate, sodium styrene sulfonate, 2-acrylamido-2-methylpropanesulfonic acid, methyl vinyl ether, vinyl acetate, and methacrylated glyco-monomers. Examples of hydrophilic monomers include but are not limited to N-Hydroxyethyl acrylamide; N-(2,3-Dihydroxypropyl) acrylamide; N-(2,3-Dihydroxypropyl) methacrylamide; N,N-dimethyl acrylamide (DMA); N-Ethyl acrylamide; N-(3-Methoxypropyl) acrylamide; 2-hydroxyethylmethacrylate (HEMA); 2-hydroxyethyl acrylate (HEA); hydroxypropyl acrylate; hydroxypropyl methacrylate (HPMA); N-[Tris(hydroxymethyl)methyl]acrylamide; trimethylammonium 2-hydroxy propylmethacrylate hydrochloride; dimethylaminoethyl methacrylate (DMAEMA); glycerol methacrylate (GMA); N-vinyl-2-pyrrolidone (NVP); dimethylaminoethyl methacrylamide; (meth)acrylamide; allyl alcohol; vinyl pyridine; N-(1,1-dimethyl-3-oxobutyl) acrylamide; acrylic acid (AA); methacrylic acid (MAA); N-(2-methacryloyloxy)ethyl-N,N-dimethylamino propane sulfonate; N-(3-methacryloylimino) propyl-N,N-dimethylammino propane sulfonate; N-(3-methacryloylimino) propyl-N,N-dimethylammino propane sulfonate; 2-(methacryloyloxy)ethyl phosphatidylcholine and 3-(2′-vinyl-pyridinio) propane sulfonate, 6-O-vinylsebacyl-D-glucose, fructose methacrylate, glucose methacrylate, ribose methacrylate, mannitol methacrylate, sorbitol methacrylate, methacrylated oligosaccharides, methacrylated oligo-fructose, 2-Acetoacetoxy-ethyl Methacrylates, Tetrahydrofurfuryl Methacrylates; 2-Hydroxyethyl Methacrylates/Succinates; 2-Hydroxyethyl Methacrylate Phosphates; Hepta-O-benzyl monomethacryloyl sucrose.

Examples of hydrophobic monomers include but are not limited to Methyl methacrylate; glycidyl methacrylate; ethyl methacrylate; butyl methacrylate; hexyl methacrylate; tert-butyl methacrylate; cyclohexyl methacrylate; Isobornyl Methacrylates; 2-ethylhexyl methacrylate; heptyl methacrylate; octal methacrylate; Lauryl methacrylate; 2,2,2-trifluoroethyl methacrylate; 1,1-dihydroperfluoroethylacrylate; 1H,1H, 7H-dodecafluoroheptyl acrylate; hexafluoroisopropyl acrylate; 1H,1H,2H,2H-heptadecafluorodecyl acrylate; pentafluorostyrene; trifluoromethyl styrene; pentafluoroethyl acrylate; pentafluoroethyl methacrylate; hexafluoroisopropyl acrylate; hexafluoroisopropyl methacrylate (HFIPMA); methacrylate-functionalized fluorinated polyethylene oxides; 3-Methacryloxypropyl Tris-(Trimethylsiloxy) Silane; 3-Methacryloxypropyl Tris-(Trimethylsiloxy) Silane; Methacryloxyethoxytris-(Trimethylsiloxy) Silane; Trimethylsilylmethyl Methacrylate; (3-Methacryloxy-2-hydroxypropoxy)-propylbis(trimethylsiloxy)methylsilane; 1H,1H, 11H-Eicosafluoroundecyl Methacrylate; 1H, 1H,9H-Hexadecafluorononyl Acrylate; 4-Vinylbenzyl Hexafluoroisopropyl Ether; Pentafluorobenzyl Acrylate; Pentafluorobenzyl Methacrylate; Perfluorocyclohexyl Methyl Acrylate; Perfluorocyclohexylmethyl Methacrylate; m-Fluorostyrene; and the like.

Examples of Amphiphilic Monomers include but are not limited to 2-Methoxyethoxyethyl Methacrylates; Ethoxyethyl Methacrylates; 2-(dimethylamino)ethyl methacrylate; 2-(diethylamino)ethyl methacrylate; N-[3-(Dimethylamino)-propyl]acrylamide; N-[3-(Dimethylamino) propyl]meth-acrylamide; Hydroxy oligo (ethylene glycol) 6 methacrylate; Methoxy oligo (ethylene glycol): methacrylate; N-(1,1-di(O-B-D-glucorpyranosyloxymethyl)-1-(undecyl carbamoyloxymethyl)methyl) acrylamide; 5-acrylamido-5-undecylcarbamoyloxymethyl-2.2-dimethyl-cyclol, 3 dioxahexane; N-(1,1-(2′,3′,4′6″tetra-O-acetyl-B-D-glucopyranosyloxy-methyl)-1-(undecylcarbamoyl oxymethyl)-methyl)-acryl-amide; N-1,1-di(hydroxymethylmethyl)-1 (undecylcarbamoyl Oxymethyl)-methyl) acrylamide; N-(1,1-(2, 3, 4, 6-″tetra-O-acetyl-ft-D-glucopyranosyloxy-methyl)-1-(undecyl carbamoyloxymethyl)-methyl)-acryl-amide; (2-Hydroxy-3-Methacryloxypropyl) Trimethylammonium Chloride; acrylamide functionalized Polyetheramine such as Acrylamide derivatives of polyether amines. Polyetheramines are available from Huntsman Chemical and sold under the trade name “Jeffamine” (examples of polyether amines include Jeffamine M-(600, 1000, 2005, 2070)

Acrylamide derivatives of polyether amines may be formed through reaction of a polyetheramine with reagents such as methacrylic anhydride or acryloyl chloride as shown in Scheme 1, where hydrophilic/lipophilic balance (HLB) depends on values of X and Y and where X and Y are whole numbers.

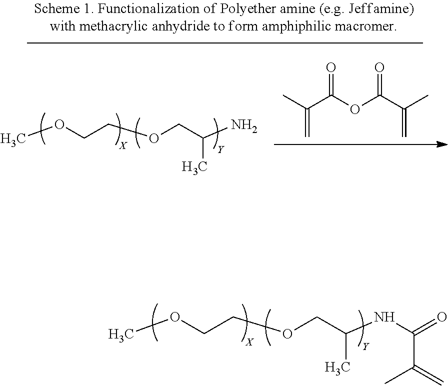

Zwitterionic Monomers include, but are not limited to, 1-(3-Sulfopropyl)-2-Vinylpyridinium Betaine; N-(3-Sulfopropyl)-N-Methacryloxyethyl-N,N-Dimethylammonium Betaine; and N-(3-Sulfopropyl)-N-Methacryloylamidopropyl-N,N-Dimethylammonium Betaine.

Examples of antimicrobial monomers include but are not limited to 2 (Methacryloyloxy)-ethyl]-trimethylammonium chloride; 2-(methacryloxy)ethyl]dimethyl dodecyl ammonium chloride; 2-(methacryloxy)ethyl]-dimethyl hexadecyl ammonium chloride; 2-(methacryloxy) decyl]dimethyl hexadecyl ammonium chloride; 2-(methacryloxy)-dodecyl]dimethyl hexadecyl ammonium chloride; 2-(methacryloxy) hexadecyl]dimethyl hexadecyl ammonium chloride; [2-(methacryloxyethyl]azabicyclo[2.2.2]ammonium chloride; 1-{2-[(2-methylprop-2-enoyl)oxy]ethyl}pyridin-1-ium chloride; 1-{2-[(2-methylprop-2enoyl)oxy]decyl}pyridin-1-ium chloride; 1-{2-[(2-methylprop-2-enoyl)oxy]dodecyl}pyridin-1-ium chloride; 1-{2-[(2-methylprop-2-enoyl)oxy]hexadecyl}pyridin-1-ium chloride; and the like.

Examples of macromonomers include but are not limited to Poly(dimethylsiloxane), monomethacrylate terminated; Poly(dimethylsiloxane), monoacrylate terminated; Poly(dimethylsiloxane), monomethacrylamide terminated; Poly(dimethylsiloxane), monoacrylamide terminated; Polydimethylsiloxane-diacrylamide; Polydimethylsiloxane-dimethacrylamide; Polydimethylsiloxane-dimethacrylate; Polydimethylsiloxane-diacrylate; polyethyleneglycol-methacrylate, and the like.

In some examples, the additional monomer comprises diallyl amine, 2-hydroxyethyl methacrylate, 2-aminoethyl methacrylate hydrochloride, glycerolmonomethacrylate, N,N-dimethylacrylamide, N-Hydroxyethyl acrylamide, N-(3-Hydroxypropyl)-acrylamide, N-(2,3-dihydroxypropyl) acrylamide, a quaternary ammonium chloride methacrylamide-functionalized polydimethylsiloxane (QAM-PDMS), a quaternary ammonium chloride methacrylate-functionalized polydimethylsiloxane (QA-MA-PDMS), or a combination thereof.

In some examples, the additional monomer comprises a quaternary ammonium chloride methacrylamide-functionalized polydimethylsiloxane (QAM-PDMS), for example as shown in the following formula:

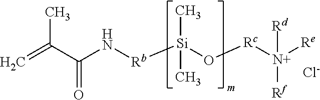

wherein
m is an integer from 1 to 10,000; and
R^{b}, R^{c}, R^{d}, R^{e}, and R^{f} are each independently alkyl, alkenyl, alkynyl, cycloalkyl, aryl, alkylaryl, or heteroaryl.

In some examples, the additional monomer comprises a quaternary ammonium chloride methacrylate-functionalized polydimethylsiloxane (QA-MA-PDMS), for example as shown in the following formula:

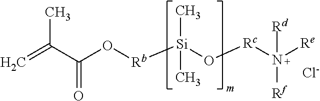

wherein
m is an integer from 1 to 10,000; and
R^{b}, R^{c}, R^{d}, R^{e}, and R^{f} are each independently alkyl, alkenyl, alkynyl, cycloalkyl, aryl, alkylaryl, or heteroaryl.

In some examples, the composition further comprises a chain transfer agent to regulate molecular weight. Suitable chain transfer agents include, but are not limited to, 2-mercapto-ethanol, butyl mercaptan, dodecyl mercaptan, L-cysteine, dibutyl disulfide, and tertiary-dibutyl disulfide.

In some examples, the composition further comprises an initiator (e.g., a photo-initiator, a thermal initiator), a crosslinker, an additional monomer, a UV-blocker, a blue light blocker, a dye, a pigment, a solvent, an additional antimicrobial agent, or a combination thereof.

Suitable photo-initiators include, but are not limited to, acetophenone; anisoin; anthraquinone; benzoin; benzoin methyl ether; benzoin ethyl ether; benzoin isobutyl ether; diethoxyacetophenone; benzoylphosphine oxide; 1-hydroxycyclohexyl phenyl ketone; 50/50 blend of Benzophenone/1-Hydroxycyclohexyl phenylketone; 2,2-Diethoxyacetophenone; 4,4′-Dihydroxybenzophenone; 2,2-Dimethoxy-2-phenylacetophenone; 4-(Dimethylamino)-benzophenone; 4,4′-Dimethyl-benzyl; 2,5-Dimethylbenzophenone; 3,4-Dimethylbenzophenone; Diphenyl(2,4,6-trimethylbenzoyl) phosphine oxide/2-Hydroxy-2-methylpropiophenone; 50/50 blend; 4′-Ethoxyacetophenone; 3′-Hydroxyacetophenone; 4′-Hydroxyacetophenone, 3-Hydroxybenzophenone; 4-Hydroxybenzophenone; 1-Hydroxycyclohexyl phenyl ketone; 2-Methyl-4′-(methylthio)-2-morpholinopropiophenone; Phenanthrenequinone, 4′-Phenoxy-acetophenone; Thioxanthen-9-one; DARACURE® types (e.g., DARACURE® 1173); Irgacure® types (e.g., Irgacure 1173 and Irgacure® 2959); and UV/visible light photo initiators (Available from Spectra Group and sold under the trade names H-Nu 470, H-Nu 535, H-Nu 635).

Examples of thermal initiators include, but are not limited to, azo type initiators such as: 2,2′-azobis(2,4-dimethylpentanenitrile), 2,2′-azobis(2-methylpropanenitrile), 2,2′-azobis(2-methylbutanenitrile), Azobisisobutyronitrile (trade name VAZO 64); 2,2′-Azodi(2-methylbutyronitrile) (trade name VAZO 67); 2-2′-Azobis(2,4-dimethylvaleronitrile) (trade name VAZO 52); and 1,1′-Azobis(cyanocyclohexane) (trade name VAZO 88). In some examples, the thermal initiator is 2,2′-Azobis-(isobutyronitrile) (AIBN). One skilled in the art will recognize that polymerization and curing of formulations containing azo type initiators can also be triggered with UV-light.

Other types of initiators include organic peroxy compounds such as: benzoyl peroxide; tert-Butyl hydro peroxide; tert-Butyl per acetate, t-butyl peroxyneodecanoate; t-butyl peroxypivalate; tertiary-butyl peroxyisopropyl carbonate; cumene hydro peroxide; 2,5-Di(tert-butylperoxy)-2,5-dimethyl-3-hexyne; Dicumyl peroxide; 2,5-Bis(tert-butylperoxy)-2,5-dimethylhexane; 2,5-Bis(tert-butylperoxy)-2,5-dimethylhexane; 1,1-Bis(tert-butylperoxy)-3,3,5-trimethylcyclohexane; 1,1-Bis(tert-butylperoxy)cyclohexane; tert-Butyl peroxide; Lauryl peroxide and the like. Many peroxy based initiators are sold under the trade name Luperox and are available from ARKEMA.

In some examples, two or more of the various types of initiators can be combined in the compositions described herein. For example, the compositions can comprise a combination of one or more thermal initiators and one or more photo-initiators. Compositions comprising both a thermal initiator and a photo-initiator can be subjected to both photocuring (e.g., with UV light) and thermal curing. For example, the composition can be partially cured with UV light followed by thermal curing and post curing.

Crosslinkers include, for example, vinylic crosslinkers, difunctional isocyanate crosslinkers, difunctional epoxide crosslinkers, difunctional alkyl halides (e.g., difunctional acid halides), difunctional-anhydrides, bis-halo-alkyl derivatives, activated esters, or any number of difunctional reagents capable for forming chemical bonds with polyglycerol OH groups.

Examples of vinylic crosslinkers include but are not limited to: Ethylene glycol dimethacrylate; Triethylene glycol dimethacrylate; Diethyleneglycol Dimethacrylate; 1,3-Glycerol Dimethacrylate; 1,6-Hexanediol Dimethacrylate; 1,12-Dodecanediol Dimethacrylate; Trimethylolpropane Trimethacrylate; Poly(Ethyleneglycol) (400) Dimethacrylate; Isophorone Urethane Dimethacrylate; N,N′-Methylenebisacrylamide; 1,6-Hexamethylene bis-Methacrylamide; N,N′-Hexamethylenebismethacrylamide; N,N′-iso-Valerylidene bis-Methacrylamide; N,N′-Nonamethylenebisacrylamidem-Xylenebisacrylamide; 1,10-Decamethylene Glycol Diacrylate; 1,2-Propanediol Diacrylate; 1,3-Butanediol Diacrylate; 1,3-Propanediol Diacrylate; 1,4-Cyclohexanedimethyl Diacrylate; 1,5-Pentanediol Diacrylate; 1,9-Nonanediol Diacrylate; 2,2,3,3,4,4,5,5-Octafluoro-1,6-Hexanediol Diacrylate; 2,2,3,3-Tetrafluoro-1,4-Butanediol Diacrylate; 2-Butene-1,4-Diacrylate; Aliphatic Urethane Acrylate in Tripropylene Glycol Diacrylate; Diethylene Glycol Diacrylate; Ethylene Diacrylate; neo-Pentyl Glycol Diacrylate; Sorbitol Diacrylate; Hexamethylene Diacrylate; Thiol Diethylene Glycol Diacrylate; Tetraethylene Glycol Diacrylate; Triethylene Glycol Diacrylate; Bisphenol A Glycidyl Methacrylate; Pentaerythritol Tetramethacrylate; 1,3-Divinyltetramethyl-disiloxane; 3-Methacryloxypropyl Tris-(Vinyldimethylsiloxy) Silane; 1,1,5,5-Tetrahydroperfluoro-1,5-Pentanediol Dimethacrylate; 2,2,3,3,4,4,5,5-Octafluoro-1,6-Hexanediol Diacrylate; 2,2,3,3,4,4,5,5-Octafluoro-1,6-Hexanediol Dimethacrylate; divinylbenzene; diallylbutyl ether; diallylbisphenol-A; polydimethylsiloxane-diacrylamide; polydimethylsiloxane-dimethacrylamide; polydimethylsiloxane-dimethacrylate; and polydimethylsiloxane-diacrylate.

Examples of difunctional isocyanate crosslinkers include but are not limited to: Isophorone diisocyanate (IPDI), hexamethylene diisocyanate (HDI), methylene dicyclohexyl diisocyanate, toluene diisocyanate (TDI), Tolylene-2,4-diisocyanate, Tolylene-2,6-diisocyanate, trans-1,4-Cyclohexylene diisocyanate, Poly(propylene glycol), tolylene 2,4-diisocyanate terminated, 1,4-Diisocyanatobutane, 1,8-Diisocyanatooctane, 1,3-Bis(1-isocyanato-1-methylethyl)benzene, 2,2,4-Trimethylhexamethylene Diisocyanate, 2,4,4-Trimethylhexamethylene Diisocyanate, 1,4-Phenylene diisocyanate, 1,3-Phenylene diisocyanate, m-Xylylene diisocyanate, methylenediphenyl diisocyanate (MDI), and diisocyanate-terminated polydimethylsiloxane. Depending on the ratio of diisocyanate, chain extension or crosslinking can occur.

Examples of difunctional epoxide crosslinkers include but are not limited to: diglycidyl ether, Bisphenol A diglycidyl ether, Glycerol diglycidyl ether, resorcinol diglycidyl ether, diglycidyl ether, bis(3,4-epoxycyclohexylmethyl) adipate, poly(ethylene glycol) diglycidyl ether, Bis[4-(glycidyloxy)phenyl]methane, 1,3-Butadiene diepoxide, 1,4-Butanediol diglycidyl ether, 1,4-Butanediol diglycidyl ether, 1,3-Butanediol diglycidyl ether, Bisphenol F diglycidyl ether, Bisphenol A propoxylate diglycidyl ether, neopentyl glycol diglycidyl ether, N,N-Diglycidyl-4-glycidyloxyaniline, 4,4′-Isopropylidenediphenol diglycidyl ether, Poly(propylene glycol) diglycidyl ether, Dicyclopentadiene dioxide, 1,2,5,6-Diepoxycyclooctane, 1,2,7,8-Diepoxyoctane, Diglycidyl 1,2-cyclohexanedicarboxylate, 3,4-Epoxycyclohexylmethyl 3,4-epoxycyclohexanecarboxylate, 2,5-bis[(2-oxiranylmethoxy)-methyl]-furan (BOF) and 2,5-bis[(2-oxiranylmethoxy)methyl]-benzene, Poly(dimethyl siloxane), tetraglycidyl-4,4′-diaminodiphenylmethane (TGDDM), tri-glycidyl-aminophenol, e. 3-(3-glycidoxypropyl)-1,1,1,3,5,5,5-heptamethyltrisiloxsane, 1-epoxyethyl-3,4-epoxycyclohexane, 1,3,5-Triglycidyl isocyanurate, PC-1000 Epoxy Siloxane Monomer (available from Polyset), PC-1035 Epoxy Siloxane Monomer (available from Polyset), Poly(dimethylsiloxane), diglycidyl ether terminated (average Mn ~800, available from SIGMA ALDRICH), epoxy terminated Poly(dimethylsiloxanes) available from Shin Etsu Silicone Company and sold under the trade names KF-105; X-22-163A; X-22-163B; X-22-163C; X-22-169AS; X-22-169B available from Shin Etsu Silicone Company; bis[2-(3,4-epoxycyclohexyl)-ethyl tetramethyldisiloxane, and 2,4,6,8-Tetramethyl-2,4,6,8-tetrakis(propyl glycidyl ether)cyclotetrasiloxane. Depending on the ratio of diepoxide, chain extension or crosslinking can occur.

Examples of difunctional alkyl halides include but are not limited to: 1,4-Dibromobutane, 1,5-Dibromopentane, 1,6-Dibromohexane, 1,8-Dibromooctane. Depending on the ratio of diepoxide, chain extension or crosslinking can occur.

Examples of difunctional acid chlorides include but are not limited to: malonyl chloride, isophthaloyl di-acid chloride, sebacoyl chloride, dodecanedioyl dichloride, octanedioic acid dichloride, fumaryl chloride, glutaryl chloride. Depending on the ratio of diacid chloride, chain extension or crosslinking can occur.

Examples of difunctional-anhydrides include but are not limited to: Diethylene-triaminepentaacetic dianhydride, 4,4′-(4,4′-Isopropylidenediphenoxy)bis(phthalic anhydride), 4,4′-(Hexafluoroisopropylidene)-diphthalic anhydride, bis(phthalic anhydride), 4,4′-Oxydiphthalic anhydride, 3,3′,4,4′-Biphenyltetracarboxylic dianhydride, Benzophenone-3,3′,4,4′-tetracarboxylic dianhydride, and Pyromellitic di-anhydride. Silicones containing two or more anhydride groups per polymer chain many also be used as crosslinkers. The dual end anhydride terminated Poly(dimethylsiloxanes) available from Shin Etsu Silicone Company and sold under the trade name X-22-2290AS may also be used as a crosslinking agent. Depending on the ratio of dianhydride, chain extension or crosslinking can occur.

Examples of Bis-haloalkylether-derivatives include: Bis(chloromethyl) ether, Bis(bromomethyl) ether, bis(iodomethyl) ether, bis(chloroethyl) ether, bis(bromoethyl) ether, bis(iodoethyl) ether.

Activated Esters such as: 3,3′-Dithiodipropionic acid di(N-hydroxysuccinimide ester) may also be used.

Examples of UV-Blockers include: 2-[3-(2H-Benzotriazol-2-yl)-4-hydroxyphenyl]ethyl methacrylate; 2-{2′-Hydroxy-5′-(γ-propoxy)-3′-t-butylphenyl}-5-methoxy-2H-benzotriazole, 2-(2H-Benzotriazol-2-yl)-4-methyl-6-(2-propenyl) phenol; and 1-(2-METHYL-ALLYL)-1H-BENZOTRIAZOLE; 2-hydroxy-4-Acryloyloxy-benzophenone).

Examples of Blue Light Blockers include, but are not limited to, various yellow and/or orange dyes. Examples of yellow dyes include but are not limited to: N,N-bis-(2-allylcarbomatoethyl)-(4′-phenylazo) aniline; N,N-bis-(2-hydroxyethyl)-(4-phenylazo) aniline; N,N-bis-(2-vinylacetoxyethyl)-(4′-phenylazo) aniline; and N-2-[3′-2″-methylphenylazo)-4′-hydroxyphenyl]ethylvinylacetamide. Examples of orange dyes include but are not limited to: Reactive Orange 16, Reactive Orange 13 (PROCION ORANGE H-2R), disperse orange 3 acrylamide, disperse orange 3 meth-acrylamide, disperse orange 3 acrylate, disperse orange 3 methacrylate, disperse orange 25 acrylamide, disperse orange 25 methacrylamide, disperse orange 25 acrylate, and disperse orange 25 methacrylate, Reactive orange dye containing vinyl sulfone.

Solvents include, but are not limited to: alcohols such as methanol, ethanol, isopropanol, 1-propanol, n-butanol, tertbutyl alcohol, t-amyl alcohol; Isoamyl alcohol; Benzyl alcohol; 2-Ethylhexanolethyleneglycol, propylene glycol; ethyl lactate, cyclopentanone, 2-ethoxyethanol, glycerin, 2-Butoxyethanol; Propylene Glycol Monomethyl Ether; Decyl Alcohol; Cyclohexanol; Diethylene glycol monobutyl ether; Glymes such as Ethylene glycol dimethyl ether; Ethylene glycol diethyl ether; Diethylene glycol dimethyl ether; Dipropylene glycol dimethyl ether; Diethylene glycol dibutyl ether; Poly(ethylene glycol) dimethyl ether; Tetraethylene glycol dimethyl ether; Ethyl Acetate; Propyl Acetate; n-Butyl Acetate; t-Butyl Acetate; Propylene carbonate; Dimethyl carbonate; Diethyl carbonate; 2 Ethylhexyl Acetate; Butyrolactone; Acetone, methyl ethyl ketone, cyclopentanone; cyclohexanone; 2-heptanone, -methyl-2-hexanone; Acetyl acetone; Ethyl propionate; Methyl isobutyl ketone; 2-Butoxyethanol acetate; Bis(2-ethylhexyl) adipate; Methyl phenyl acetate; Methyl lactate; Hexyl acetate; Dimethyl form amide, N-methylpyrolidone, 2-Methyl-tetrahydrofuran; N,N-dimethyl lactamide, Tetrahydrothiophene (Sulfolane), acetamide, dimethyl acetamide. Mixtures formed by combining two or more of the solvents can also be used.

In some examples, the composition further comprises an additional antimicrobial agent. In some examples, the additional antimicrobial agent comprises a quaternary ammonium compound, an antimicrobial metal, or a combination thereof. In some examples, the additional antimicrobial agent comprises a quaternary ammonium compound. In some examples, the additional antimicrobial agent comprises an antimicrobial metal comprising Ag, Au, Pt, Pd, Ir, Sn, Cu, Sb, Bi, or Zn. In some examples, the additional antimicrobial agent comprises a plurality of nanoparticles comprising the antimicrobial metal.

In some examples, the composition is non-leaching.

In some examples, the composition exhibits antimicrobial activity. In some examples, the composition exhibits antimicrobial activity with a log reduction of 1 or more, 2 or more, 3 or more, 4 or more, 5 or more, 6 or more, or 10 or more.

Also disclosed herein are crosslinked compositions, for example comprising any of the compositions described herein crosslinked with a crosslinker. In some examples, the crosslinker comprises a vinylic crosslinker, difunctional isocyanate crosslinker, difunctional epoxide crosslinker, difunctional alkyl halide, difunctional anhydride, a bis-halo-alkylether derivative, an activated ester, or combination thereof. In some examples, the crosslinked composition the composition is non-leaching. In some examples, the crosslinked composition exhibits antimicrobial activity. In some examples, the crosslinked composition exhibits antimicrobial activity with a log reduction of 1 or more, 2 or more, 3 or more, 4 or more, 5 or more, 6 or more, or 10 or more.

Also disclosed herein are interpenetrating polymer networks. An “interpenetrating polymer network” (IPN) as used herein refers broadly to an intimate network of two or more polymers at least one of which is either synthesized and/or crosslinked in the presence of the other(s). Techniques for preparing IPN are known to one skilled in the art. For a general procedure, see U.S. patent Numbers: U.S. Pat. Nos. 4,536,554; 4,983,702; 5,087,392; and 5,656,210, the contents of which are all incorporated herein by reference.

For example, also disclosed herein are interpenetrating polymer networks comprising any of the compositions disclosed herein crosslinked with a crosslinker in the presence of an initiator, an additional monomer, a UV-blocker, a blue light blocker, a dye, a pigment, a solvent, an additional antimicrobial agent, or a combination thereof. In some examples, the crosslinker comprises a vinylic crosslinker, difunctional isocyanate crosslinker, difunctional epoxide crosslinker, difunctional alkyl halide, difunctional anhydride, a bis-halo-alkylether derivative, an activated ester, or combination thereof. In some examples, the interpenetrating polymer network is non-leaching. In some examples, the interpenetrating polymer network exhibits antimicrobial activity. In some examples, the interpenetrating polymer network exhibits antimicrobial activity with a log reduction of 1 or more, 2 or more, 3 or more, 4 or more, 5 or more, 6 or more, or 10 or more.

### Devices and Methods of Use

Also described herein are methods of use of any of the compositions described herein.

For example, the compositions described herein can be used in the construction of medical devices, as coatings for medical devices, and any number of other biomedical applications.

For example, also described herein are methods of use of any of the compositions described herein, for example in medical devices and ophthalmic applications such as contact lenses.

The methods of use can, for example, comprise using any of the compositions, crosslinked compositions and/or interpenetrating polymer networks described herein in the construction of medical devices, as coatings for medical devices, and any number of other biomedical applications.

For examples, the methods can comprise using the composition, the crosslinked composition, the interpenetrating polymer network, or combination thereof in a medical device. Examples of medical devices include, but are not limited to, catheters, ophthalmic devices, endoscopes, cell growth platforms, microfluidic devices, implants that come into contact with tissue (e.g., epithelial tissue, connective tissue, muscle tissue, and nerve tissue) and/or biological fluids (e.g., blood, mucus, urine, tears, saliva, amniotic fluid, synovial fluid), wound dressings, sutures, ventilator tubes, intravenous lines, stents, and combinations thereof. In some examples, the medical device comprises an ophthalmic device. In some examples, the ophthalmic device comprises a contact lens, an intraocular lens, a corneal inlay, an eye bandage, a drug delivery device, a prosthetic device, or a combination thereof.

In some examples, the composition, the crosslinked composition, the interpenetrating polymer network, or combination thereof is chemically bound to the medical device, such as to a surface of the medical device.

In some examples, the composition, the crosslinked composition, the interpenetrating polymer network, or combination thereof is incorporated within the bulk of the medical device.

Also disclosed herein are methods of use of any of the compositions, crosslinked compositions, and/or interpenetrating polymer networks described herein in an ophthalmic device. In some examples, the ophthalmic device comprises a contact lens, an intraocular lens, a corneal inlay, an eye bandage, a drug delivery device, a prosthetic device, or a combination thereof. In some examples, the composition, the crosslinked composition, the interpenetrating polymer network, or combination thereof is chemically bound to the ophthalmic device, such as to a surface of the ophthalmic device. In some examples, the composition, the crosslinked composition, the interpenetrating polymer network, or combination thereof is incorporated within the bulk of the ophthalmic device.

Also disclosed herein are methods of use of any of the compositions, crosslinked compositions, and/or interpenetrating polymer networks described herein as a coating for a medical device. In some examples, the coating is chemically bound to the medical device, such as to a surface of the medical device. In some examples, the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof. In some examples, the medical device comprises an ophthalmic device. In some examples, the ophthalmic device comprises a contact lens, an intraocular lens, a corneal inlay, an eye bandage, a drug delivery device, a prosthetic device, or a combination thereof.

Also disclosed herein are methods of use of any of the compositions, crosslinked compositions, and/or interpenetrating polymer networks described herein as a wound dressing. In some examples, the composition, the crosslinked composition, the interpenetrating polymer network, or combination thereof is chemically bound to the wound dressing, such as to a surface of the wound dressing. In some examples, the composition, the crosslinked composition, the interpenetrating polymer network, or combination thereof is incorporated within the bulk of the wound dressing.

In some examples, the wound dressing exhibits efficient mass transfer of oxygen, antimicrobial agents, antifungal agents, antiviral agents, fluids (e.g., liquor puris), gases (e.g., CO₂), or a combination thereof. For example, a wound dressing capable of efficient mass transfer of oxygen, antimicrobial agents, antifungal agents, and antiviral agents, fluid (e.g. liquor puris), and gases (oxygen, CO₂) would be highly effective in facilitating wound healing.

Examples of antimicrobial agents include but are not limited to (neomycin, bacitracin, Penicillin, Penicillin G, Amoxicillin, Ampicillin, Cloxacillin, Methicillin, Amoxicillin+Clavulanate (Augmentin), Ticarcillin+Clavulanate, Nafcillin, Cefuroxime, Lacking Urine, Cefotaxime, Cefoperazone, Cephtriaxone, Cefepime, Tetracycline, Minocycline, Doxycycline, Azithromycin, Erithromycin, Clarithromycin, Clindamycin, Sulfamethoxazole-Trimethoprim, Ciprofloxacin (Cipro), Norfloxacin, Ofloxacin, Levofloxacin, Streptomycin, Tobramycin, Gentamycin, Amikacin). Examples of antifungal agents include but are not limited to (Amphotericin B, Candicidin, Bifonazole, Albaconazole, Amantadine, Amprenavir, Atazanavir, Efavirenz, Ibacitabine, Umifenovir, Abafungin, Ciclopirox, Norvir, Peramivir, Podophyllotoxin, Saquinavir, Sofosbuvir). Examples of antiviral agents include but are not limited to (Acyclovir, Trifluridine, Zanamivir, Ribavirin, Tenofovir, Tromantadine).

The compositions, crosslinked compositions, and/or interpenetrating polymer networks described herein can also be used in cases that require mass transfer of one or more of the following types of species: ionic species, gases, oxygen, pharmacologically active substances, biomolecular species, and fluids. Examples of ionic species include but are not limited to potassium salts, sodium salts, calcium salts, magnesium salts, silver salts, copper salts, iron salts, aluminum salts, chloride salts, bromide salts, fluoride salts, iodide salts, Sulphur salts, phosphate salts, and borate salts. Examples of gases include but are not limited to CO₂, NO (nitric oxide), N₂O (nitrous oxide), NO₂ (nitrogen dioxide), water vapor, O₂, O₃, NH₃, boron tri-fluoride (BF₃), sulfur hexafluoride (SF₆), silane (SiH₄), silicon tetrachloride (SiCl₄), silicon tetrafluoride (SiF₄), PH₃, phosgene (COCl₂), carbon monoxide (CO), sulfur dioxide (SO₂), methane (CH₄), ethane (C₂H₆), propane (C₃H₈), cyclopropane (C₃H₆), butane (C₄H₁₀), cyclobutane (C₄H₈), acetylene, chlorine, fluorine, argon, neon, krypton, radon, xenon, hydrogen cyanide, hydrogen sulfide, HCl, HF, HBr, nitrogen (N₂), hydrogen (H₂), chlorofluorocarbons (CFCs), and hydro-chlorofluorocarbons (HCFCs),

Also disclosed herein are articles of manufacture and devices comprising any of the compositions, crosslinked compositions, and/or interpenetrating polymer networks described herein. Such articles of manufacture and devices can be fabricated by methods known in the art.

In some examples, the article of manufacture comprises a medical device. In some examples, the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof. In some examples, the article of manufacture comprises an ophthalmic device wherein the ophthalmic device comprises a contact lens, an intraocular lens, a corneal inlay, an eye bandage, a drug delivery device, a prosthetic device, or a combination thereof.

In some examples, the article of manufacture can comprise a membrane prepared from any of the compositions, crosslinked compositions, and/or interpenetrating polymer networks described herein. The membrane can, for example, allow for efficient permeation of small molecules and ions.

In some examples, the article of manufacture comprises a contact lens.

Also disclosed herein are contact lenses comprising any of the compositions, crosslinked compositions, and/or interpenetrating polymer networks described herein.

In some examples, the composition, the crosslinked composition, the interpenetrating polymer network, or combination thereof is chemically bound to the contact lens, such as to a surface of the contact lens. In some examples, the composition, the crosslinked composition, the interpenetrating polymer network, or combination thereof is incorporated within the bulk of the contact lens.

Also disclosed herein are contact lenses comprising a coating comprising any of the compositions, crosslinked compositions, and/or interpenetrating polymer networks described herein. In some examples, the coating is chemically bound to the contact lens, such as to a surface of the contact lens.

In some examples, the contact lens or membrane can allow for efficient transport of water, ions, oxygen, and nutrients.

In some examples, any of the compositions, crosslinked compositions, and/or interpenetrating polymer networks described herein can be used to make soft (hydrophilic) contact lenses with or without decorative print patterns (e.g., soft contact lenses that are optionally cosmetically tinted). For example, soft contact lenses that are cosmetically tinted can be prepared from formulations comprising the any of the compositions, crosslinked compositions, and/or interpenetrating polymer networks described herein and a dye and/or a pigment.

In some examples, the contact lens comprises a soft, hydrophilic contact lens.

In some examples, the contact lens is cosmetically tinted.

In some examples, the contact lens is antimicrobial.

In some examples, the contact lens is antifouling.

Also disclosed herein are methods of treating, preventing, inhibiting, and/or ameliorating an infection in a subject. For example, the methods can comprise using any of the compositions, crosslinked compositions, interpenetrating polymer networks, medical devices, ophthalmic devices, wound dressings, and/or contact lenses in the subject.

### Methods of Making

Also described herein are methods of making any of the compositions, crosslinked compositions, interpenetrating polymer networks, medical devices, ophthalmic devices, wound dressings, and/or contact lenses described herein.

For example, also described herein are methods of making any of the crosslinked compositions described herein, methods comprising crosslinking any of the compositions described herein. In some examples, the method comprises mixing the composition with the crosslinker to form a mixture and crosslinking the mixture. In some examples, the crosslinking is performed with the aid of thermal energy, actinic radiation, or a combination thereof. In some examples, the crosslinking comprises thermal curing and/or UV-curing. In some examples, the mixture further comprises an initiator, an additional monomer, a UV-blocker, a blue light blocker, a dye, a pigment, a solvent, an additional antimicrobial agent, or a combination thereof. In some examples, the mixture further comprises an additional antimicrobial agent. In some examples, the additional antimicrobial agent comprises a quaternary ammonium compound, an antimicrobial metal, or a combination thereof. In some examples, the additional antimicrobial agent comprises a quaternary ammonium compound. In some examples, the additional antimicrobial agent comprises an antimicrobial metal comprising Ag, Au, Pt, Pd, Ir, Sn, Cu, Sb, Bi, or Zn. In some examples, the additional antimicrobial agent comprises a plurality of nanoparticles comprising the antimicrobial metal.

Also disclosed herein are methods of making any of the interpenetrating polymer networks described herein. For example, the methods can comprise mixing any of the compositions described herein with a crosslinker in the presence of an initiator, an additional monomer, a UV-blocker, a blue light blocker, a dye, a pigment, a solvent, an additional antimicrobial agent, or a combination thereof, to thereby form a mixture, and crosslinking the composition. In some examples, the crosslinking is performed with the aid of thermal energy, actinic radiation, or a combination thereof. In some examples, the crosslinking comprises thermal curing and/or UV-curing. In some examples, the mixture comprises the additional antimicrobial agent. In some examples, the additional antimicrobial agent comprises a quaternary ammonium compound, an antimicrobial metal, or a combination thereof. In some examples, the additional antimicrobial agent comprises a quaternary ammonium compound. In some examples, the additional antimicrobial agent comprises an antimicrobial metal comprising Ag, Au, Pt, Pd, Ir, Sn, Cu, Sb, Bi, or Zn. In some examples, the additional antimicrobial agent comprises a plurality of nanoparticles comprising the antimicrobial metal.

Also described herein are methods of making any of the antimicrobial copolymers described herein.

For example, also described herein are methods of making an antimicrobial contact lens. In some examples, the method comprises coating a contact lens with an antimicrobial copolymer, such as any of the antimicrobial copolymers described herein, and immobilizing the coating on the surface of the contact lens. In some examples, the method comprises introducing an amount of a co-polymerizable formulation in a mold for making a contact lens, polymerizing the co-polymerizable formulation to form a contact lens, coating a surface of the contact lens with an antimicrobial copolymer, such as any of the antimicrobial copolymers described herein, and immobilizing the coating on the surface of the contact lens.

The coating can be applied to the contact lens using a variety of technologies such as dip coating, in package coating, pad printing, inkjet printing, and spray coating. The coating can be immobilized, for example, using either heat or actinic radiation.

In some examples, the methods of making the antimicrobial copolymer comprise that shown in Scheme 2 below. In some examples, the composition can be subsequently UV-cured.

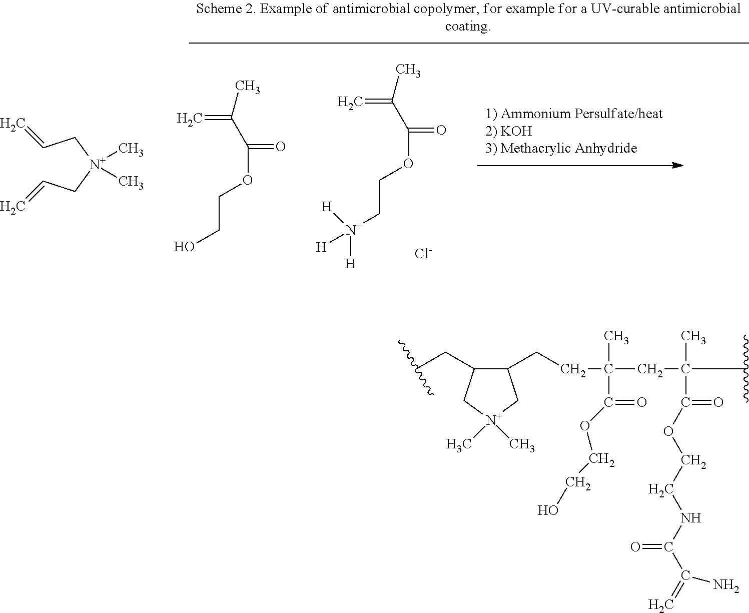

In some examples, the methods of making the antimicrobial copolymer comprise that shown in Scheme 3 and/or Scheme 4 below. In some examples, the composition can be used as a nucleophilic antimicrobial coating.

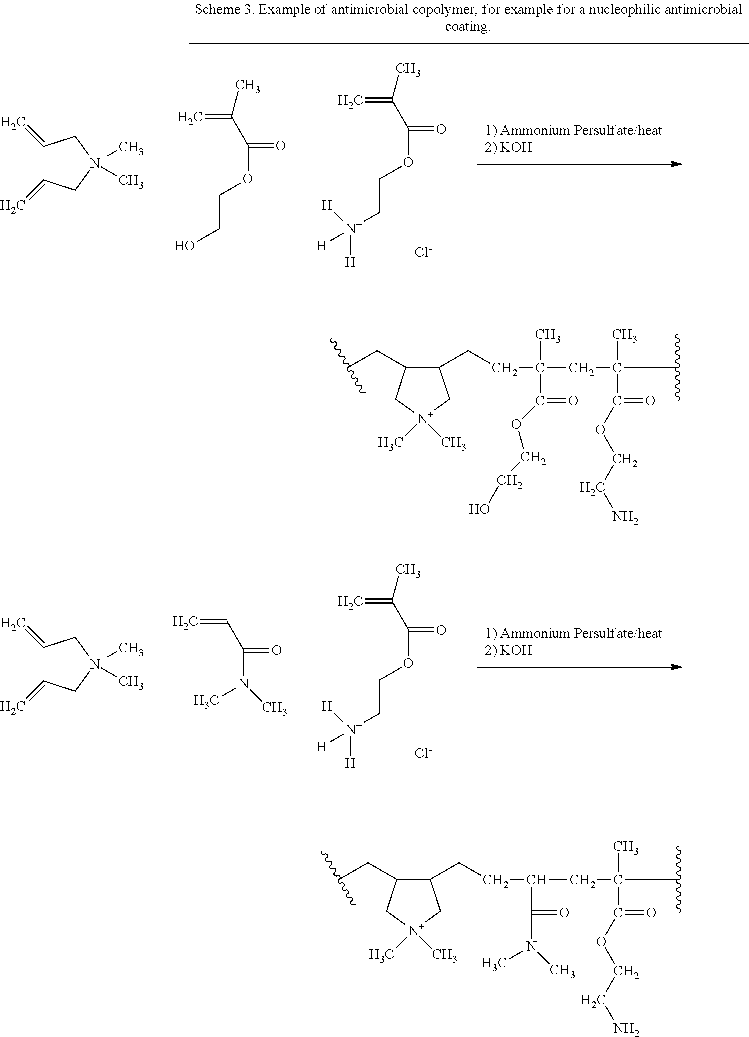

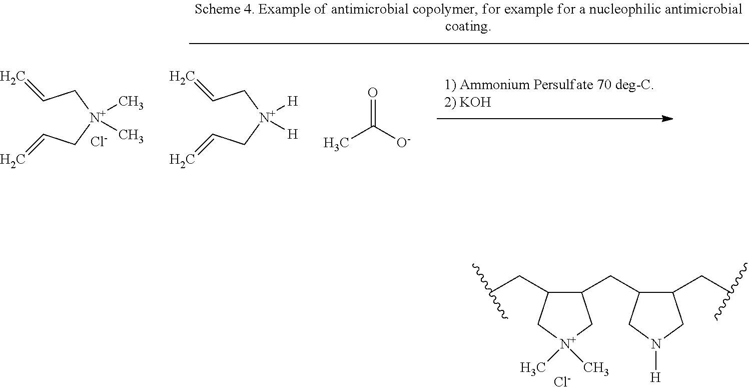

In some examples, the methods of making the antimicrobial copolymer comprise that shown in Scheme 5 and/or Scheme 6 below. In some examples, the composition can be subsequently actinically cured. In some examples, the composition can be used as an antimicrobial coating.

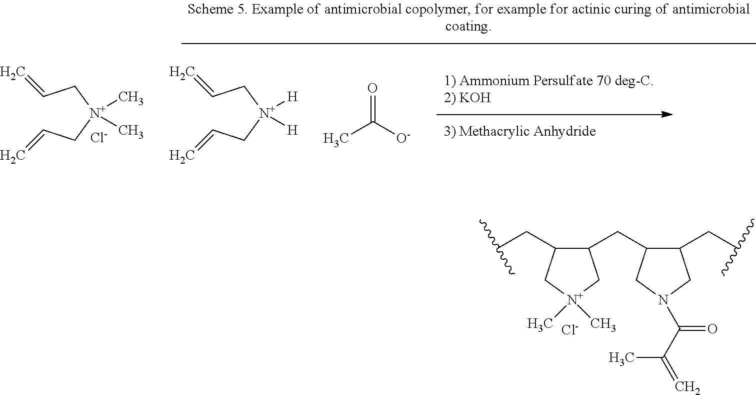

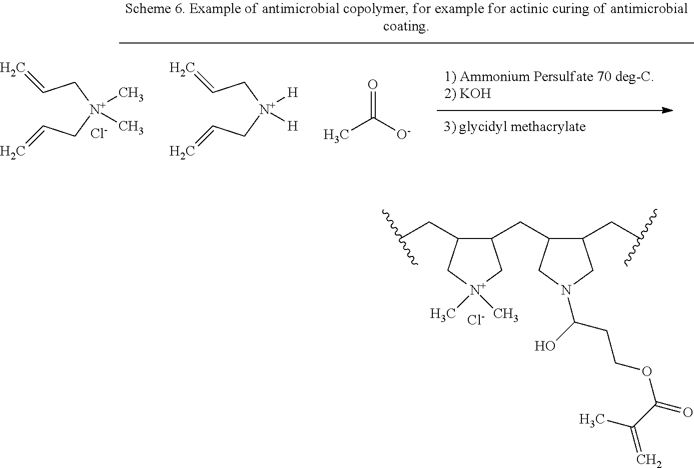

In some examples, the methods of making the antimicrobial copolymer comprise that shown in Scheme 7 below. In some examples, the composition can be used as an electrophilic antimicrobial coating. In some examples, the composition can subsequently be thermally cured.

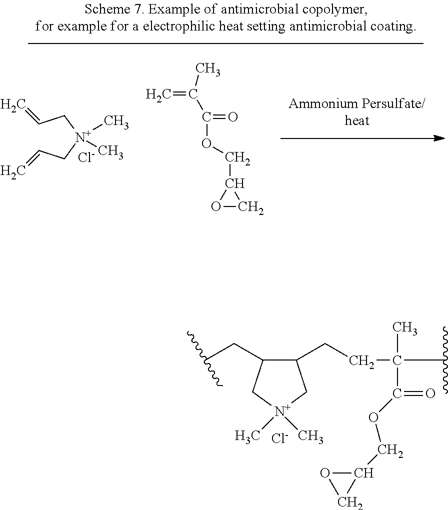

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Non-Leaching Antimicrobial Coatings

Described herein are non-leaching antimicrobial coatings. Said coatings can permanently bond an antimicrobial substance to a medical device, such as a contact lens or wound dressing. The coatings are non-leaching, and therefore do not migrate into the eye or tissue. The coatings described herein can be used to prevent infection.

Poly(diallyldimethyl ammonium chloride) (shown below), has antimicrobial properties.

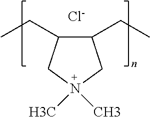

In the compositions described herein, chemical hooks and/or reactive sites are added for permanent bonding (Scheme 8). The free amine can, for example, react with an ester. The methacrylamide copolymer can be crosslinked, for example by heat or UV curing. The methacrylamide can also be mixed with monomers and polymerized, for example to form an interpenetrating polymer network.

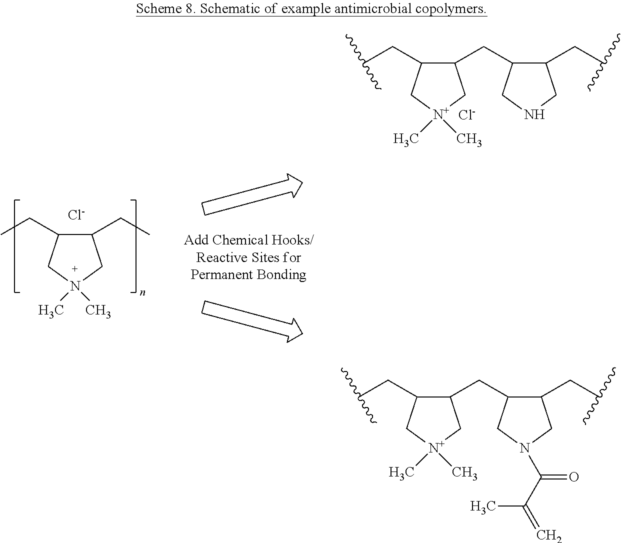

Various antimicrobial copolymers (e.g., 1002-170-1, 1002-174-1, 1002-171-2, 1002-175-2 (high MW), and 1002-177-2 (lower MW)) described below have reactive groups.

The antimicrobial coatings can be applied via different methods.

In some examples, the non-leaching antimicrobial coatings can be applied in package or by dip coating, followed by thermal curing (Scheme 9). For example, the coating is applied on one or both sides of the contact lens, for example by dip coating, spray coating, transfer printing, etc., and then thermally cured.

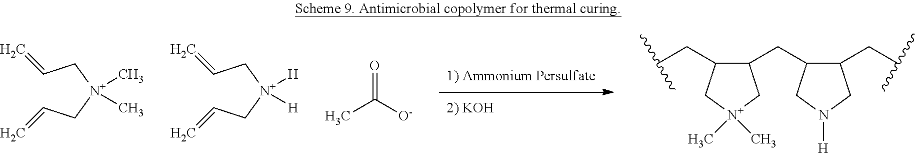

In some examples, the non-leaching antimicrobial copolymer can be applied as an antimicrobial coating on a contact lens or added to a contact lens formulation, followed by UV curing (Scheme 10).

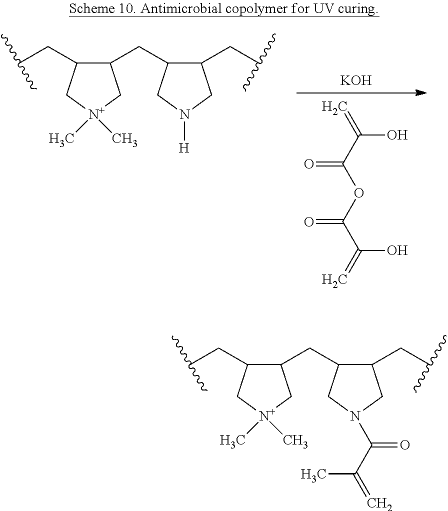

### Example 2-(1002-170-1) Poly(diallyldimethyl ammonium chloride-Co-diallyl amine)

A glass jar was charged with diallyl amine (4.51 grams) and glacial acetic acid (~2.87 grams). To this was added 55.03 grams of a 65% aqueous solution of diallyl dimethyl ammonium chloride and 0.254 grams of ammonium persulfate (dissolved in 25 mL of purified water). Nitrogen was bubbled through the solution for 15 minutes. The jar was sealed and the sample was heated at 70° C. for 20 hours or until allyl functionality was no longer visible by FTIR. At the end of the reaction, the polymerization solution was noticeably more viscous compared to the starting solution.

An aqueous solution containing 6.75 grams of KOH and 20 mL of water was added to the reaction mixture followed by thorough mixing. The reaction mixture was transferred to dialysis tubing (Regenerated Cellulose, molecular weight cut off (MWCO) of 6000-8000 Daltons). The reaction mixture was dialyzed against water for 24 hours. During this time, the water was replaced with fresh water every few hours, 4 times in total. The solution was concentrated by rotary evaporation until the solids content of 7-10% was obtained.

A schematic illustration of the copolymer in this example is shown below:

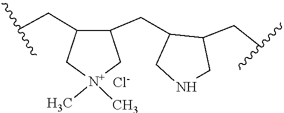 [SMILES: *CC1CNCC1CC1C[N+](C)(C)CC1C* ; [Cl-]]

### Example 3-Copolymer (1002-171-2)

A glass bottle was charged with diallyl amine (2.07 grams), acetic acid (1.60 grams), 55.95 grams of 65% aqueous solution of diallyl-dimethyl ammonium chloride and ammonium persulfate (0.283 grams) followed by mixing. The resulting solution was sparged with nitrogen for 5 minutes and the bottle was sealed and placed in a 70° C. oven for 18 hours to yield a viscous solution. A solution containing KOH (3.5 grams) in 20 mL of water was added to the reaction mixture followed by thorough mixing. A solution containing methacrylic anhydride (4.92 grams) in 20 mL of isopropanol was added to the reaction mixture followed by thorough mixing and heating at 40° C. for 2 hours. The copolymer solution was transferred to dialysis tubing (Regenerated cellulose, Molecular weight cut off 6000-8000 Daltons) and dialyzed against 50% aqueous solution of isopropanol. The dialyzed sample was concentrated by rotary evaporation to a solids content of 19%.

A schematic illustration of the copolymer in this example is shown below:

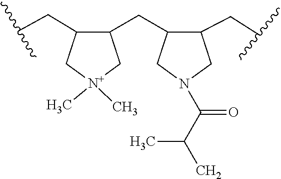 [SMILES: *CC1CN(C(=O)C(C)C)CC1CC1C[N+](C)(C)CC1C*]

### Example 4—Copolymer (1002-174-1)

Acetic acid (4.09 grams) was combined with diallyl amine (4.51 grams). The neutralized diallyl amine was combined with diallyl dimethyl ammonium chloride (82.09 grams, 65% aqueous solution), and 2-hydroxyethyl methacrylate (12.12 grams). To this solution, ammonium persulfate (0.234 grams) dissolved in 10 mL of water was added. After mixing thoroughly, 2-mercaptoethanol (0.185 grams) was added to the reaction mixture. The reaction mixture was vigorously sparged with nitrogen for 2 minutes, and the vessel was sealed. The sealed reaction vessel was placed in a 70° C. oven for 14 hours to yield a viscous solution. After cooling, KOH (4.62 grams) dissolved in 25 mL of water was added to the reaction mixture followed by thorough mixing. The reaction mixture was then dialyzed using regenerated cellulose (MWCO 600-8000 Daltons) against water and concentrated to 11% solids by rotary evaporation.

A schematic illustration of the copolymer in this example is shown below:

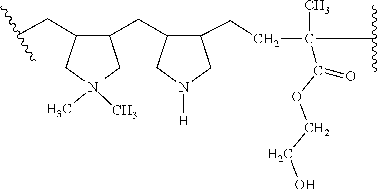 [SMILES: *CC1C[N+](C)(C)CC1CC1CNCC1CCC(*)(C)C(=O)OCCO]

### Example 5—Copolymer (1002-175-2)

A glass jar was charged with diallyldimethyl ammonium chloride (152.06 grams), 2-aminoethyl methacrylate hydrochloride (9.45 grams), 2-hydroxyethyl methacrylate (22.37 grams) and 0.569 grams of ammonium persulfate dissolved in 5 mL of water. The resulting solution was thoroughly mixed and then vigorously sparged with nitrogen for 5 minutes followed by sealing of the jar. The sealed jar was placed in a 70° C. oven for 22 hours to yield a viscous solution. After cooling, KOH (6.56 grams) dissolved in 25 mL of water was added to the reaction mixture followed by the addition of methacrylic anhydride (14.59 grams). The reaction mixture was diluted with 300 mL of water and 300 mL of methanol and then heated at 40° C. for 3 hours. The reaction mixture was then poured into 4 liters of stirred isopropanol. The resulting precipitate was collected and dialyzed (regenerated cellulose, MWCO, 6000-8000 Daltons) against water for 24 hours. The sample was concentrated by rotary evaporation to a solids content of 5.2% solids.

A schematic illustration of the copolymer in this example is shown below (high MW):

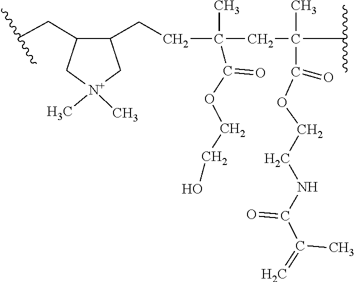 [SMILES: *CC1C[N+](C)(C)CC1CCC(C)(CC(*)(C)C(=O)OCCNC(=O)C(=C)C)C(=O)OCCO]

### Example 6—Copolymer (1002-177-2)

A glass jar was charged with diallyldimethyl ammonium chloride (153.55 grams), 2-Aminoethyl methacrylate hydrochloride (7.82 grams), 2-hydroxyethyl methacrylate (23.13 grams), 2-mercaptoethanol (0.337 grams) and 0.569 grams of ammonium persulfate dissolved in 5 mL of water. The resulting solution was thoroughly mixed and then vigorously sparged with nitrogen for 3 minutes followed by sealing of the jar. The sealed jar was placed in a 70° C. oven for 21 hours to yield a viscous solution. After cooling, KOH (5.46 grams) dissolved in 20 mL of water was added to the reaction mixture followed by the addition of methacrylic anhydride (11.05 grams) dissolved in 25 mL of methanol. The resulting copolymer was then dialyzed (regenerated cellulose, MWCO, 6000-8000 Daltons) against water for 24 hours. The sample was concentrated by rotary evaporation to a solids content of 7% solids.

A schematic illustration of the copolymer in this example is shown below (lower MW):

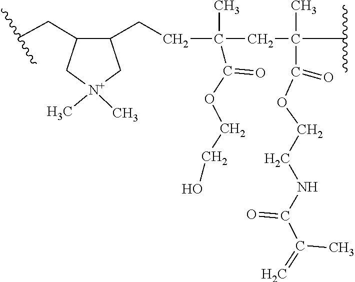 [SMILES: *CC1C[N+](C)(C)CC1CCC(C)(CC(*)(C)C(=O)OCCNC(=O)C(=C)C)C(=O)OCCO]

### Example 7—Copolymer (1002-161-1)

A glass jar was charged with 65% aqueous diallyl dimethyl ammonium chloride (74.26 grams), diallylamine (3.57 grams), and 0.284 grams of ammonium persulfate dissolved in 25 mL of water. The resulting solution was thoroughly mixed and then vigorously sparged with nitrogen for 10 minutes followed by sealing of the jar. The sealed jar was placed in a 70° C. water bath for 20 hours to yield a viscous solution. The resulting solution was dialyzed (regenerated cellulose, MWCO, 6000-8000 Daltons) against 20% ethanol/80% water for 24 hours. The sample was concentrated by rotary evaporation to a solids content of 9.5% solids.

### Example 8—Preparation of Boric Acid Solution

The boric acid solution used in the extraction of contact lenses was prepared from a solution comprised of boric acid (240 grams), sodium hydroxide (40 grams), Tween 20 (0.1375 grams), Tween 80 (0.1375 grams) and 5 liters of water.

### Example 9—Procedure for Testing Antimicrobial Activity

Filter paper was placed in 6 well plates and each well was filled with 900 microliters of water. An empty well was filled with water to maintain humidity. The 6-well plate was disinfected by irradiating with UVC for 10 minutes. Sterile contact lenses were removed from blister packages and placed on wet filter paper in each well. Each contact lens was inoculated with 10 microliters of 1×10⁸ E. coli 8739 cells/mL. The 6 well plates were covered and transferred to a 37° C. incubator for 4 hours. Trypticase Soy Agar (TSA) plates were prepared. Microtubes were filled with 0.99 mL of phosphate-buffered saline. Each contact lens was removed from the 6-well plate using sterilized tweezers and placed in a microtube. The samples were mixed using a vortex mixer. Each sample (0.1 mL) was plated on TSA. The plated samples were incubated at 37° C. overnight. The next day E. coli colonies were counted, and log reductions were determined.

### Example 10—T1

Silicone hydrogel contact lenses seated in base curve molds were submerged in an aqueous solution containing 3% Copolymer prepared as described in Example 2 for 30 minutes after which the excess solution was poured off. The lenses, while still in base curve molds, were heated at 110° C. for 60 minutes. The lenses were removed from molds and extracted in a boric acid solution prepared as described in Example 8. The extracted contact lenses were packaged in borate-buffered saline, and sterilized at 121° C. in an autoclave. Contact lenses were evaluated for antimicrobial activity using E. coli 8739 according to the procedure described in Example 9. The lenses showed antimicrobial activity with a log reduction of 5.

### Example 11—T2

Silicone hydrogel contact lenses seated in base curve molds were submerged in an aqueous solution containing 3% Copolymer prepared as described in Example 3, 0.5% 2-hydroxyethyl methacrylate (HEMA) and 0.025% ammonium persulfate for 30 minutes after which excess solution was poured off. The lenses, while still in base curve molds, were heated at 75° C. for 60 minutes. The lenses were removed from molds and extracted in a boric acid solution prepared as described in Example 8. The extracted contact lenses were packaged in borate-buffered saline, and sterilized at 121° C. in an autoclave. The coated contact lenses were tested for antimicrobial activity using E. coli 8739 according to the procedure described in Example 9. The lenses showed antimicrobial activity with a log reduction of 2.

### Example 12—T3

Silicone hydrogel contact lenses seated in base curve molds were submerged in an aqueous solution containing 3% Copolymer prepared as described in Example 4, and 0.025% ammonium persulfate for 30 minutes after which excess solution was poured off. The contact lenses, while still in base curve molds, were heated at 110° C. for 60 minutes. The lenses were removed from molds and extracted in a boric acid solution prepared as described in Example 8. The extracted contact lenses were packaged in borate-buffered saline and sterilized at 121° C. in an autoclave. The coated contact lenses were tested for antimicrobial activity against E. coli 8739 according to the procedure described in Example 9. The lenses showed antimicrobial activity with a log reduction of 2.

### Example 13—T4

Silicone hydrogel contact lenses seated in base curve molds were submerged in an aqueous solution containing 3% Copolymer prepared as described in Example 5, 0.5% 2-hydroxyethyl methacrylate (HEMA) and 0.025% ammonium persulfate for 30 minutes after which the excess solution was poured off. The lenses, while still in base curve molds, were heated at 75° C. for 60 minutes. The lenses were removed from molds and extracted in a boric acid solution prepared as described in Example 8. The extracted contact lenses were packaged in borate-buffered saline, and sterilized at 121° C. in an autoclave. The coated contact lenses were tested for antimicrobial activity using E. coli 8739 according to the procedure described in Example 9. The lenses showed antimicrobial activity with a log reduction of 1.

### Example 14—T5

Silicone hydrogel contact lenses seated in base curve molds were submerged in an aqueous solution containing 3% Copolymer prepared as described in Example 6, 0.5% 2-hydroxyethyl methacrylate (HEMA), and 0.025% ammonium persulfate for 30 minutes after which the excess solution was poured off. The lenses, while still in base curve molds, were heated at 75° C. for 60 minutes. The lenses were removed from molds and extracted in a boric acid solution prepared as described in Example 8 and sterilized at 121° C. in an autoclave. The coated contact lenses were assessed for antimicrobial activity using E. coli 8739 according to the procedure described in Example 9. The lenses showed antimicrobial activity with a log reduction of 1.

### Example 15—T6

Silicone hydrogel contact lenses seated in base curve molds were submerged in an aqueous solution containing 3% Copolymer prepared as described in Example 3, 0.5% 2-hydroxyethyl methacrylate (HEMA), and 0.025% Irgacure 2959 (2-hydroxy-1-[4-(hydroxyethoxy)phenyl]-2-methyl-1-propanone) for 30 minutes after which excess solution was poured off. The lenses, while still in base curve molds, were cured with UVA light at 3 mW/cm² for 60 minutes. The lenses were removed from molds and extracted in a boric acid solution prepared as described in Example 8 and sterilized at 121° C. in an autoclave. The coated contact lenses were evaluated for antimicrobial activity using E. coli 8739 according to the procedure described in Example 9. The lenses showed antimicrobial activity with a log reduction of 4.

### Example 16—T7

Silicone hydrogel contact lenses seated in base curve molds were submerged in an aqueous solution containing 3% Copolymer prepared as described in Example 5, 0.5% 2-hydroxyethyl methacrylate (HEMA), and 0.025% Irgacure 2959 for 30 minutes after which excess solution was poured off. The lenses, while still in base curve molds, were cured with UVA light at 3 mW/cm² for 60 minutes. The lenses were removed from molds and extracted in a boric acid solution prepared as described in Example 8. The extracted contact lenses were packaged in borate-buffered saline, and sterilized at 121° C. in an autoclave. The coated contact lenses were evaluated for antimicrobial activity using E. coli 8739 according to the procedure described in Example 9. The lenses showed antimicrobial activity with a log reduction of 3.

### Example 17—T8

Silicone hydrogel contact lenses seated in base curve molds were submerged in an aqueous solution containing 3% Copolymer prepared as described in Example 6, 0.5% 2-hydroxyethyl methacrylate (HEMA), and 0.025% Irgacure 2959 for 30 minutes after which excess solution was poured off. The lenses, while still in base curve molds, were cured with UVA light at 3 mW/cm² for 60 minutes. The lenses were removed from molds and extracted in a boric acid solution prepared as described in Example 8 and sterilized at 121° C. in an autoclave. The coated contact lenses were tested for antimicrobial activity using E. coli 8739 according to the procedure described in Example 9. The lenses showed antimicrobial activity with a log reduction of 3.

### Example 18—P9-1

Silicone hydrogel contact lenses were placed in blister packages containing borate-buffered saline containing 0.5% copolymer from Example 7. The blisters were sealed, and the contact lenses were autoclave sterilized at 121° C. for 30 minutes. The lenses were removed from molds and extracted for 1 hour in 70% isopropanol, followed by extraction with water for 1 hour. The contact lenses were packaged in borate-buffered saline and sterilized at 121° C. in an autoclave for 30 minutes. The coated contact lenses were evaluated for antimicrobial activity using E. coli 8739 according to the procedure described in Example 9. The lenses showed antimicrobial activity with a log reduction of 6.

### Example 19—P5-3

Silicone hydrogel contact lenses were placed in blister packages containing borate-buffered saline containing 0.5% copolymer from Example 7 and 0.0075% hydrogen peroxide. The blisters were sealed, and the contact lenses were autoclave sterilized at 121° C. for 30 minutes. The lenses were removed from molds and extracted for 1 hour in 70% isopropanol, followed by extraction with water for 1 hour. The contact lenses were packaged in borate-buffered saline and sterilized at 121° C. in an autoclave for 30 minutes. The coated contact lenses were evaluated for antimicrobial activity using E. coli 8739 according to the procedure described in Example 9. The lenses showed antimicrobial activity with a log reduction of 6.

### Example 20—P9-1

Silicone hydrogel contact lenses were placed in blister packages containing borate-buffered saline containing 1% copolymer from Example 7. The blisters were sealed, and the contact lenses were autoclave sterilized at 121° C. for 30 minutes. The lenses were removed from molds and extracted for 1 hour in 70% isopropanol, followed by extraction with water for 1 hour. The contact lenses were packaged in borate-buffered saline and sterilized at 121° C. in an autoclave for 30 minutes. The coated contact lenses were stored in an incubator with 5% CO₂ for 1 week and then evaluated for antimicrobial activity using E. coli 8739 according to the procedure described in Example 9. No growth was observed.

### EXEMPLARY ASPECTS

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A composition comprising an antimicrobial copolymer derived from diallyldimethyl ammonium chloride (DADMAC), wherein the antimicrobial copolymer comprises a curable or reactive group, and the curable or reactive group is thermally and/or actinically curable.

Example 2: The composition of any examples herein, particularly example 1, wherein the antimicrobial copolymer is derived from diallyldimethyl ammonium chloride (DADMAC) and a curable monomer (e.g., one or more curable monomers), said curable monomer comprising said curable or reactive group.

Example 3: The composition of any examples herein, particularly example 1 or example 2, wherein the antimicrobial copolymer derived from diallyldimethyl ammonium chloride (DADMAC) and a bifunctional vinylic monomer (e.g., one or more bifunctional vinylic monomers), the bifunctional vinylic monomer comprising said curable or reactive group.

Example 4: The composition of any examples herein, particularly examples 1-3, wherein the curable or reactive group comprises an ethylenically unsaturated group, a hydroxyl group, an amino group, an epoxy group, a thiol group, or a combination thereof.

Example 5: The composition of any examples herein, particularly examples 1-4, wherein the curable or reactive group comprises an ethylenically unsaturated group.

Example 6: The composition of any examples herein, particularly example 5, wherein the ethylenically unsaturated group comprises acryloyl, acrylamide, alkyl acrylamide, dialkyl acrylamide, methacryloyl, allyl, vinyl, styrenyl, or a combination thereof.

Example 7: The composition of any examples herein, particularly examples 1-6, wherein the antimicrobial copolymer is defined by Formula I:

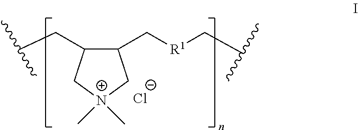

wherein
R¹ comprises the curable or reactive group; and
n is an integer from 1 to 10,000.

Example 8: The composition of any examples herein, particularly example 7, wherein n is an integer from 50 to 10,000 or from 100 to 10,000.

Example 9: The composition of any examples herein, particularly example 7 or example 8, wherein R¹ is derived from the curable monomer.

Example 10: The composition of any examples herein, particularly examples 7-9, wherein R¹ is derived from the bifunctional vinylic monomer.

Example 11: The composition of any examples herein, particularly examples 1-10, wherein the antimicrobial copolymer is defined by Formula II:

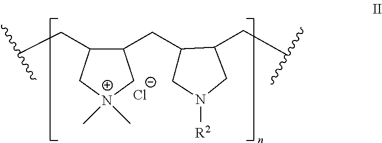

wherein
R² comprises the curable or reactive group; and
n is an integer from 1 to 10,000.

Example 12: The composition of any examples herein, particularly example 11, wherein n is an integer from 50 to 10,000 or from 100 to 10,000.

Example 13: The composition of any examples herein, particularly example 11 or example 12, wherein R² is selected from the group consisting of:

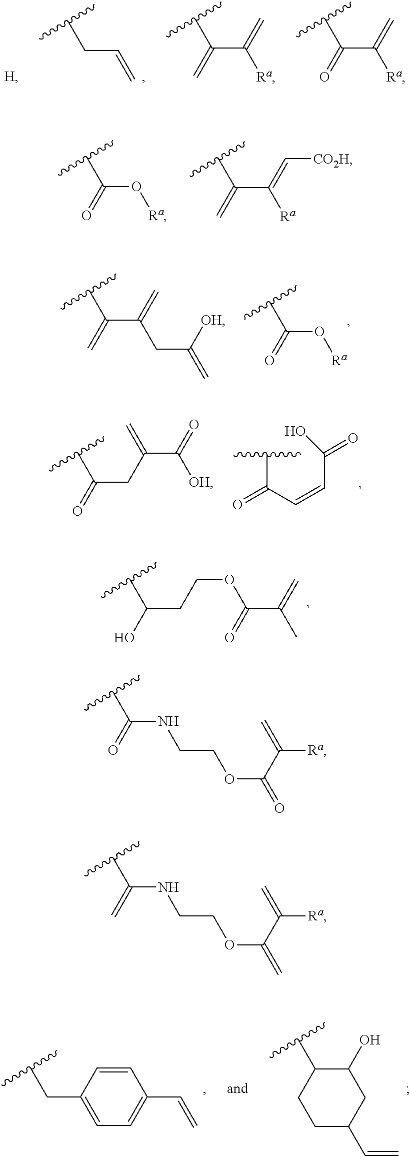

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

Example 14: The composition of any examples herein, particularly examples 1-13, wherein the antimicrobial polymer comprises a first curable or reactive group and a second curable or reactive group, each of which is thermally and/or actinically curable.

Example 15: The composition of any examples herein, particularly examples 2-14, wherein the curable monomer comprises a first curable monomer with a first curable or reactive group and a second curable monomer with a second curable or reactive group, such that the antimicrobial polymer comprises the first curable or reactive group and the second curable or reactive group, each of which is thermally and/or actinically curable.

Example 16: The composition of any examples herein, particularly examples 3-15, wherein the bifunctional vinylic monomer comprises a first bifunctional vinylic monomer with a first curable or reactive group and a second bifunctional vinylic monomer with a second curable or reactive group, such that the antimicrobial copolymer comprises the first curable or reactive group and the second curable or reactive group, each of which is thermally and/or actinically curable.

Example 17: The composition of any examples herein, particularly examples 14-16, wherein the first curable or reactive group and/or the second curable or reactive group each independently comprises an ethylenically unsaturated group, a hydroxyl group, an amino group, an epoxy group, a thiol group, or a combination thereof.

Example 18: The composition of any examples herein, particularly examples 14-17, wherein the first curable or reactive group and/or the second curable or reactive group independently comprises an ethylenically unsaturated group.

Example 19: The composition of any examples herein, particularly examples 14-18, wherein the first curable or reactive group and/or the second curable or reactive group independently comprises an ethylenically unsaturated group comprising acryloyl, acrylamide, alkyl acrylamide, dialkyl acrylamide, methacryloyl, allyl, vinyl, styrenyl, or a combination thereof.

Example 20: The composition of any examples herein, particularly examples 14-19, wherein the antimicrobial copolymer is defined by Formula III:

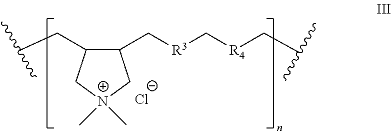

wherein
R³ comprises the first curable or reactive group;
R⁴ comprises the second curable or reactive group; and
n is an integer from 1 to 10,000.

Example 21: The composition of any examples herein, particularly example 20, wherein n is an integer from 50 to 10,000 or from 100 to 10,000.

Example 22: The composition of any examples herein, particularly example 20 or example 21, wherein R³ and/or R⁴ are independently selected from the group consisting of:

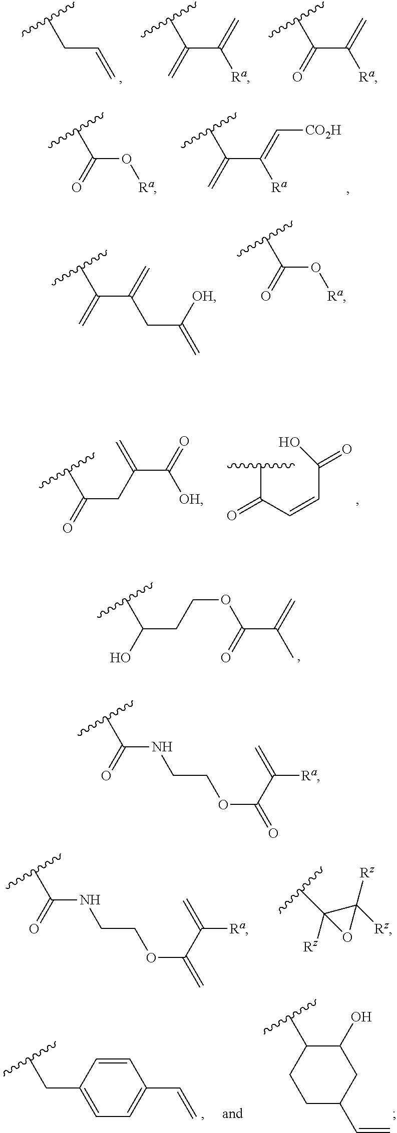

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

Example 23: The composition of any examples herein, particularly examples 14-22, wherein the antimicrobial copolymer is defined by Formula IV:

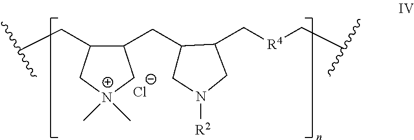

wherein
R² comprises the first curable or reactive group;
R⁴ comprises the second curable or reactive group; and
n is an integer from 1 to 10,000.

Example 24: The composition of any examples herein, particularly example 23, wherein n is an integer from 50 to 10,000 or from 100 to 10,000

Example 25: The composition of any examples herein, particularly example 23 or example 24, wherein R² is selected from the group consisting of:

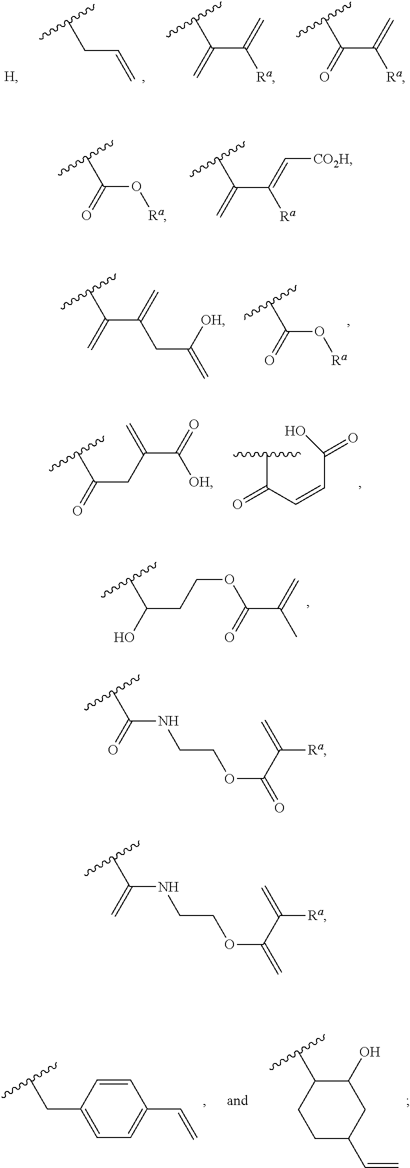

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

Example 26: The composition of any examples herein, particularly examples 23-25, wherein R⁴ is selected from the group consisting of:

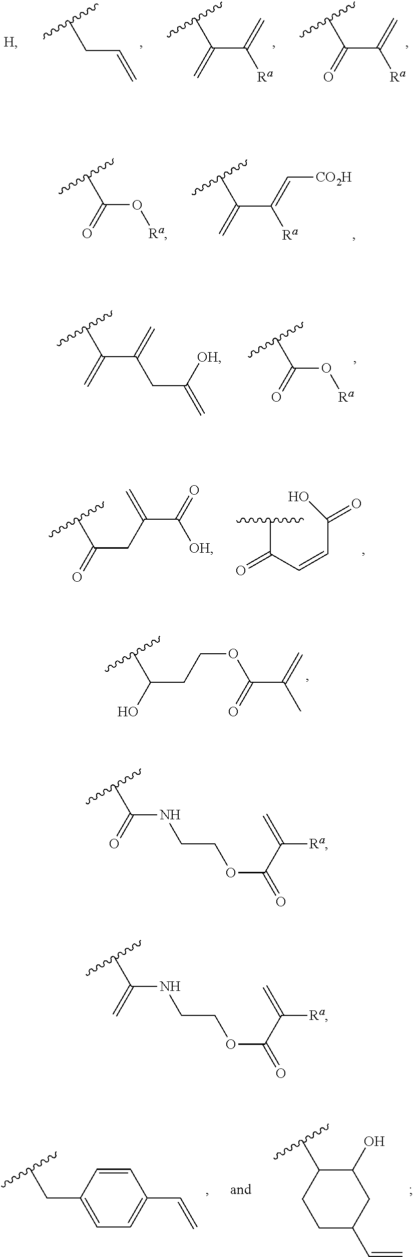

wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, 3-(Trimethoxysilyl)alkyl, Hydroxyalkoxy (alkylylbis(trimethylsilyloxy)-methylsilane, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

Example 27: The composition of any examples herein, particularly examples 1-26, wherein the antimicrobial copolymer comprises:

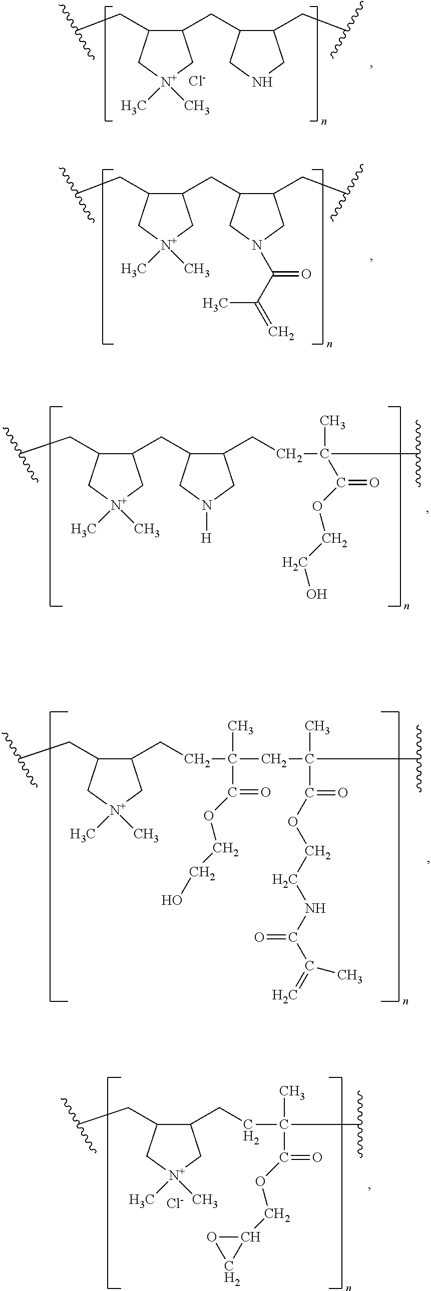

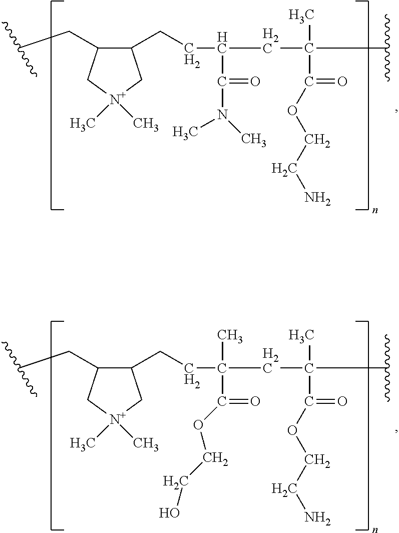

or a combination thereof, wherein each n is independently from 1 to 10,000.

Example 28: The composition of any examples herein, particularly examples 1-27, wherein the antimicrobial copolymer is further derived from an additional monomer.

Example 29: The composition of any examples herein, particularly examples 1-28, wherein the antimicrobial copolymer is further derived from an additional monomer, wherein the additional monomer comprises a hydrophilic monomer, a hydrophobic monomer, an amphiphilic monomer, a zwitterionic monomer, a macromonomer, an antimicrobial monomer, or a combination thereof.

Example 30: The composition of any examples herein, particularly examples 1-29, wherein the additional monomer comprises diallyl amine, 2-hydroxyethyl methacrylate, 2-aminoethyl methacrylate hydrochloride, glycerolmonomethacrylate, N,N-dimethylacrylamide, N-Hydroxyethyl acrylamide, N-(3-Hydroxypropyl)-acrylamide, N-(2,3-dihydroxypropyl) acrylamide, a quaternary ammonium chloride methacrylamide-functionalized polydimethylsiloxane (QAM-PDMS), a quaternary ammonium chloride methacrylate-functionalized polydimethylsiloxane (QA-MA-PDMS), or a combination thereof.

Example 31: The composition of any examples herein, particularly examples 1-30, wherein the composition further comprises a chain transfer agent to regulate molecular weight.

Example 32: The composition of any examples herein, particularly example 31, wherein the chain transfer agent comprises 2-mercaptoethanol, butyl mercaptan, dodecyl mercaptan, L-cysteine, dibutyl disulfide, tertiary-dibutyl disulfide, or a combination thereof.

Example 33: The composition of any examples herein, particularly examples 1-32, wherein the composition further comprises an initiator, a crosslinker, an additional monomer, a UV-blocker, a blue light blocker, a dye, a pigment, a solvent, an additional antimicrobial agent, or a combination thereof.

Example 34: The composition of any examples herein, particularly examples 1-33, wherein the composition further comprises an additional antimicrobial agent.

Example 35: The composition of any examples herein, particularly example 34, wherein the additional antimicrobial agent comprises a quaternary ammonium compound, an antimicrobial metal, or a combination thereof.

Example 36: The composition of any examples herein, particularly example 34 or example 35, wherein the additional antimicrobial agent comprises a quaternary ammonium compound.

Example 37: The composition of any examples herein, particularly examples 34-36, wherein the additional antimicrobial agent comprises an antimicrobial metal comprising Ag, Au, Pt, Pd, Ir, Sn, Cu, Sb, Bi, or Zn.

Example 38: The composition of any examples herein, particularly example 37, wherein the additional antimicrobial agent comprises a plurality of nanoparticles comprising the antimicrobial metal.

Example 39: The composition of any examples herein, particularly examples 1-38, wherein the composition is non-leaching.

Example 40: The composition of any examples herein, particularly examples 1-39, wherein the composition exhibits antimicrobial activity.

Example 41: The composition of any examples herein, particularly examples 1-40, wherein the composition exhibits antimicrobial activity with a log reduction of 1 or more, 2 or more, 3 or more, 4 or more, 5 or more, 6 or more, or 10 or more.

Example 42: A crosslinked composition comprising the composition of any examples herein, particularly examples 1-41 crosslinked with a crosslinker.

Example 43: The crosslinked composition of any examples herein, particularly example 42, wherein the crosslinker comprises a vinylic crosslinker, difunctional isocyanate crosslinker, difunctional epoxide crosslinker, difunctional alkyl halide, difunctional anhydride, a bis-halo-alkylether derivative, an activated ester, or combination thereof.

Example 44: The crosslinked composition of any examples herein, particularly examples 42-43, wherein the crosslinked composition is non-leaching.

Example 45: The crosslinked composition of any examples herein, particularly examples 42-44, wherein the crosslinked composition exhibits antimicrobial activity.

Example 46: The crosslinked composition of any examples herein, particularly examples 42-45, wherein the crosslinked composition exhibits antimicrobial activity with a log reduction of 1 or more, 2 or more, 3 or more, 4 or more, 5 or more, 6 or more, or 10 or more.

Example 47: An interpenetrating polymer network comprising the composition of any examples herein, particularly examples 1-41 crosslinked with a crosslinker in the presence of an initiator, an additional monomer, a UV-blocker, a blue light blocker, a dye, a pigment, a solvent, an additional antimicrobial agent, or a combination thereof.

Example 48: The interpenetrating polymer network of any examples herein, particularly example 47, wherein the crosslinker comprises a vinylic crosslinker, difunctional isocyanate crosslinker, difunctional epoxide crosslinker, difunctional alkyl halide, difunctional anhydride, a bis-halo-alkylether derivative, an activated ester, or combination thereof.

Example 49: The interpenetrating polymer network of any examples herein, particularly examples 47-48, wherein the interpenetrating polymer network is non-leaching.

Example 50: The interpenetrating polymer network of any examples herein, particularly examples 47-49, wherein the interpenetrating polymer network exhibits antimicrobial activity. Example 51: The interpenetrating polymer network of any examples herein, particularly examples 47-50, wherein the interpenetrating polymer network exhibits antimicrobial activity with a log reduction of 1 or more, 2 or more, 3 or more, 4 or more, 5 or more, 6 or more, or 10 or more.

Example 52: A method of use of the composition of any examples herein, particularly examples 1-41, the crosslinked composition of any examples herein, particularly examples 42-46, the interpenetrating polymer network of any examples herein, particularly examples 47-51, or a combination thereof, wherein the method comprises using the composition, the crosslinked composition, the interpenetrating polymer network, or combination thereof in a medical device.

Example 53: The method of any examples herein, particularly example 52, wherein the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof.

Example 54: The method of any examples herein, particularly example 52 or any examples herein, particularly example 53, wherein the medical device comprises an ophthalmic device.

Example 55: The method of any examples herein, particularly example 54, wherein the ophthalmic device comprises a contact lens, an intraocular lens, a corneal inlay, an eye bandage, a drug delivery device, a prosthetic device, or a combination thereof.

Example 56: The method of any examples herein, particularly examples 52-55, wherein the composition, the crosslinked composition, the interpenetrating polymer network, or combination thereof is chemically bound to the medical device, such as to a surface of the medical device.

Example 57: The method of any examples herein, particularly examples 52-56, wherein the composition, the crosslinked composition, the interpenetrating polymer network, or combination thereof is incorporated within the bulk of the medical device.

Example 58: The method of any examples herein, particularly examples 52-57, wherein the composition, the crosslinked composition, the interpenetrating polymer network, or combination thereof is non-leaching.

Example 59: The method of any examples herein, particularly examples 52-58, wherein the composition, the crosslinked composition, the interpenetrating polymer network, or combination thereof exhibits antimicrobial activity.

Example 60: The method of any examples herein, particularly examples 52-59, wherein the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Example 61: A method of use of the composition of any examples herein, particularly examples 1-41, the crosslinked composition of any examples herein, particularly examples 42-46, the interpenetrating polymer network of any examples herein, particularly examples 47-51, or a combination thereof, wherein the method comprises using the composition, the crosslinked composition, the interpenetrating polymer network, or combination thereof in an ophthalmic device.

Example 62: The method of any examples herein, particularly example 61, wherein the ophthalmic device comprises a contact lens, an intraocular lens, a corneal inlay, an eye bandage, a drug delivery device, a prosthetic device, or a combination thereof.

Example 63: The method of any examples herein, particularly example 61 or example 62, wherein the composition, the crosslinked composition, the interpenetrating polymer network, or combination thereof is chemically bound to the ophthalmic device, such as to a surface of the ophthalmic device.

Example 64: The method of any examples herein, particularly examples 61-63, wherein the composition, the crosslinked composition, the interpenetrating polymer network, or combination thereof is incorporated within the bulk of the ophthalmic device.

Example 65: The method of any examples herein, particularly examples 61-64, wherein the composition, the crosslinked composition, the interpenetrating polymer network, or combination thereof is non-leaching.

Example 66: The method of any examples herein, particularly examples 61-65, wherein the composition, the crosslinked composition, the interpenetrating polymer network, or combination thereof exhibits antimicrobial activity.

Example 67: The method of any examples herein, particularly examples 61-66, wherein the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Example 68: A method of use of the composition of any examples herein, particularly examples 1-41, the crosslinked composition of any examples herein, particularly examples 42-46, the interpenetrating polymer network of any examples herein, particularly examples 47-51, or a combination thereof, wherein the method comprises using the composition, the crosslinked composition, the interpenetrating polymer network, or combination thereof in as a coating for a medical device.

Example 69: The method of any examples herein, particularly example 68, wherein the coating is chemically bound to the medical device, such as to a surface of the medical device.

Example 70: The method of any examples herein, particularly example 68 or example 69, wherein the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof.

Example 71: The method of any examples herein, particularly examples 68-70, wherein the medical device comprises an ophthalmic device.

Example 72: The method of any examples herein, particularly example 71, wherein the ophthalmic device comprises a contact lens, an intraocular lens, a corneal inlay, an eye bandage, a drug delivery device, a prosthetic device, or a combination thereof.

Example 73: The method of any examples herein, particularly examples 68-72, wherein the composition, the crosslinked composition, the interpenetrating polymer network, or combination thereof is non-leaching.

Example 74: The method of any examples herein, particularly examples 68-73, wherein the composition, the crosslinked composition, the interpenetrating polymer network, or combination thereof exhibits antimicrobial activity.

Example 75: The method of any examples herein, particularly examples 68-74, wherein the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Example 76: A method of use of the composition of any examples herein, particularly examples 1-41, the crosslinked composition of any examples herein, particularly examples 42-46, the interpenetrating polymer network of any examples herein, particularly examples 47-51, or a combination thereof, wherein the method comprises using the composition, the crosslinked composition, the interpenetrating polymer network, or combination thereof as a wound dressing.

Example 77: The method of any examples herein, particularly example 76, wherein the wound dressing exhibits efficient mass transfer of oxygen, antimicrobial agents, antifungal agents, antiviral agents, fluids, gases, or a combination thereof.

Example 78: The method of any examples herein, particularly example 76 or example 77, wherein the composition, the crosslinked composition, the interpenetrating polymer network, or combination thereof is chemically bound to the wound dressing, such as to a surface of the wound dressing.

Example 79: The method of any examples herein, particularly examples 76-78, wherein the composition, the crosslinked composition, the interpenetrating polymer network, or combination thereof is incorporated within the bulk of the wound dressing.

Example 80: The method of any examples herein, particularly examples 76-79, wherein the composition, the crosslinked composition, the interpenetrating polymer network, or combination thereof is non-leaching.

Example 81: The method of any examples herein, particularly examples 76-80, wherein the composition, the crosslinked composition, the interpenetrating polymer network, or combination thereof exhibits antimicrobial activity.

Example 82: The method of any examples herein, particularly examples 76-81, wherein the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Example 83: A method of treating, preventing, inhibiting, and/or ameliorating an infection in a subject, the method comprising using the composition of any examples herein, particularly examples 1-41, the crosslinked composition of any examples herein, particularly examples 42-46, the interpenetrating polymer network of any examples herein, particularly examples 47-51, the medical device of any examples herein, particularly examples 52-60, the ophthalmic device of any examples herein, particularly examples 61-67, the medical device of any examples herein, particularly examples 68-75, or the wound dressing of any examples herein, particularly examples 76-82 in the subject.

Example 84: An article of manufacture comprising the composition of any examples herein, particularly examples 1-41, the crosslinked composition of any examples herein, particularly examples 42-46, the interpenetrating polymer network of any examples herein, particularly examples 47-51, or a combination thereof.

Example 85: The article of any examples herein, particularly example 84, wherein the article of manufacture comprises a medical device.

Example 86: The article of any examples herein, particularly example 84 or example 85, wherein the medical device comprises a catheter, an ophthalmic device, an endoscope, a cell growth platform, a microfluidic device, an implant that comes into contact with tissue and/or biological fluids, a wound dressing, sutures, a ventilator tube, an intravenous line, a stent, or a combination thereof.

Example 87: The article of any examples herein, particularly examples 84-86, wherein the article of manufacture comprises an ophthalmic device wherein the ophthalmic device comprises a contact lens, an intraocular lens, a corneal inlay, an eye bandage, a drug delivery device, a prosthetic device, or a combination thereof.

Example 88: The article of any examples herein, particularly examples 84-87, wherein the article of manufacture comprises a contact lens.

Example 89: The article of any examples herein, particularly examples 84-88, wherein the composition, the crosslinked composition, the interpenetrating polymer network, or combination thereof is non-leaching.

Example 90: The article of any examples herein, particularly examples 84-89, wherein the composition, the crosslinked composition, the interpenetrating polymer network, or combination thereof exhibits antimicrobial activity.

Example 91: The article of any examples herein, particularly examples 84-90, wherein the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Example 92: A method of treating, preventing, inhibiting, and/or ameliorating an infection in a subject, the method comprising using the article of any examples herein, particularly examples 84-91 in the subject.

Example 93: A contact lens comprising the composition of any examples herein, particularly examples 1-41, the crosslinked composition of any examples herein, particularly examples 42-46, the interpenetrating polymer network of any examples herein, particularly examples 47-51, or a combination thereof.

Example 94: The contact lens of any examples herein, particularly example 93, wherein the composition, the crosslinked composition, the interpenetrating polymer network, or combination thereof is chemically bound to the contact lens, such as to a surface of the contact lens.

Example 95: The contact lens of any examples herein, particularly example 93 or example 94, wherein the composition, the crosslinked composition, the interpenetrating polymer network, or combination thereof is incorporated within the bulk of the contact lens.

Example 96: A contact lens comprising a coating comprising the composition of any examples herein, particularly examples 1-41, the crosslinked composition of any examples herein, particularly examples 42-46, the interpenetrating polymer network of any examples herein, particularly examples 47-51, or a combination thereof.

Example 97: The contact lens of any examples herein, particularly example 96, wherein the coating is chemically bound to the contact lens, such as to a surface of the contact lens.

Example 98: The contact lens of any examples herein, particularly examples 93-97, wherein the contact lens comprises a soft, hydrophilic contact lens.

Example 99: The contact lens of any examples herein, particularly examples 93-98, wherein the contact lens is cosmetically tinted.

Example 100: The contact lens of any examples herein, particularly examples 93-99, wherein the contact lens is antimicrobial.

Example 101: The contact lens of any examples herein, particularly examples 93-100, wherein the contact lens is antifouling.

Example 102: The contact lens of any examples herein, particularly examples 93-101, the composition, the crosslinked composition, the interpenetrating polymer network, or combination thereof is non-leaching.

Example 103: The contact lens of any examples herein, particularly examples 93-102, wherein the composition, the crosslinked composition, the interpenetrating polymer network, or combination thereof exhibits antimicrobial activity.

Example 104: The contact lens of any examples herein, particularly examples 93-103, wherein the composition, the crosslinked composition, the interpenetrating polymer network, or combination thereof exhibits antimicrobial activity with a log reduction of 1 or more, 2 or more, 3 or more, 4 or more, 5 or more, 6 or more, or 10 or more.

Example 105: A method of treating, preventing, inhibiting, and/or ameliorating an infection in a subject, the method comprising using the contact lens of any examples herein, particularly examples 93-104 in the subject.

Example 106: A method of making the composition of any examples herein, particularly examples 1-41, the crosslinked composition of any examples herein, particularly examples 42-46, the interpenetrating polymer network of any examples herein, particularly examples 47-51, or a combination thereof.

Example 107: A method of making the crosslinked composition of any examples herein, particularly examples 42-46, the method comprising crosslinking the composition of any examples herein, particularly examples 1-41.

Example 108: The method of any examples herein, particularly example 107, wherein the method comprises mixing the composition with the crosslinker to form a mixture and crosslinking the mixture.

Example 109: The method of any examples herein, particularly example 107 or example 108, wherein the crosslinking is performed with the aid of thermal energy, actinic radiation, or a combination thereof.

Example 110: The method of any examples herein, particularly examples 107-109, wherein the crosslinking comprises thermal curing and/or UV-curing.

Example 111: The method of any examples herein, particularly examples 107-110, wherein the mixture further comprises an initiator, an additional monomer, a UV-blocker, a blue light blocker, a dye, a pigment, a solvent, an additional antimicrobial agent, or a combination thereof.

Example 112: The method of any examples herein, particularly examples 107-111, wherein the mixture further comprises an additional antimicrobial agent.

Example 113: The method of any examples herein, particularly example 112, wherein the additional antimicrobial agent comprises a quaternary ammonium compound, an antimicrobial metal, or a combination thereof.

Example 114: The method of any examples herein, particularly example 112 or example 113, wherein the additional antimicrobial agent comprises a quaternary ammonium compound.

Example 115: The method of any examples herein, particularly examples 112-114, wherein the additional antimicrobial agent comprises an antimicrobial metal comprising Ag, Au, Pt, Pd, Ir, Sn, Cu, Sb, Bi, or Zn.

Example 116: The method of any examples herein, particularly example 115, wherein the additional antimicrobial agent comprises a plurality of nanoparticles comprising the antimicrobial metal.

Example 117: A method of making the interpenetrating polymer network of any examples herein, particularly examples 47-51, the method comprising mixing the composition of any examples herein, particularly examples 1-41 with the crosslinker in the presence of the initiator, the additional monomer, the UV-blocker, the blue light blocker, the dye, the pigment, the solvent, the additional antimicrobial agent, or a combination thereof, to thereby form a mixture, and crosslinking the composition.

Example 118: The method of any examples herein, particularly example 117, wherein the crosslinking is performed with the aid of thermal energy, actinic radiation, or a combination thereof.

Example 119: The method of any examples herein, particularly example 117 or example 118, wherein the crosslinking comprises thermal curing and/or UV-curing.

Example 120: The method of any examples herein, particularly examples 117-119, wherein the mixture comprises the additional antimicrobial agent.

Example 121: The method of any examples herein, particularly examples 117-120, wherein the additional antimicrobial agent comprises a quaternary ammonium compound, an antimicrobial metal, or a combination thereof.

Example 122: The method of any examples herein, particularly examples 117-120, wherein the additional antimicrobial agent comprises a quaternary ammonium compound.

Example 123: The method of any examples herein, particularly examples 117-122, wherein the additional antimicrobial agent comprises an antimicrobial metal comprising Ag, Au, Pt, Pd, Ir, Sn, Cu, Sb, Bi, or Zn.

Example 124: The method of any examples herein, particularly example 123, wherein the additional antimicrobial agent comprises a plurality of nanoparticles comprising the antimicrobial metal.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A composition comprising an antimicrobial copolymer derived from diallyldimethyl ammonium chloride (DADMAC), wherein the antimicrobial copolymer comprises a curable or reactive group, and the curable or reactive group is thermally and/or actinically curable.

2. The composition of claim 1, wherein the antimicrobial copolymer is derived from diallyldimethyl ammonium chloride (DADMAC) and a curable monomer (e.g., one or more curable monomers), said curable monomer comprising said curable or reactive group.

3. The composition of claim 1, wherein the antimicrobial copolymer derived from diallyldimethyl ammonium chloride (DADMAC) and a bifunctional vinylic monomer (e.g., one or more bifunctional vinylic monomers), the bifunctional vinylic monomer comprising said curable or reactive group.

4. The composition of claim 1, wherein the curable or reactive group comprises an ethylenically unsaturated group, a hydroxyl group, an amino group, an epoxy group, a thiol group, or a combination thereof.

5. The composition of claim 1, wherein the antimicrobial copolymer is defined by Formula I: 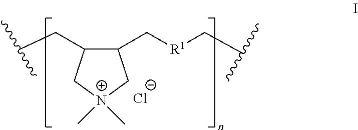
wherein
R¹ comprises the curable or reactive group; and
n is an integer from 1 to 10,000.

6. The composition of claim 1, wherein the antimicrobial copolymer is defined by Formula II: 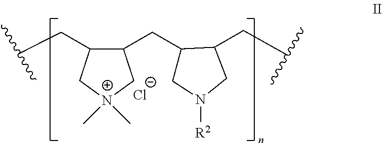
wherein
R² comprises the curable or reactive group; and
n is an integer from 1 to 10,000.

7. The composition of claim 6, wherein R² is selected from the group consisting of: 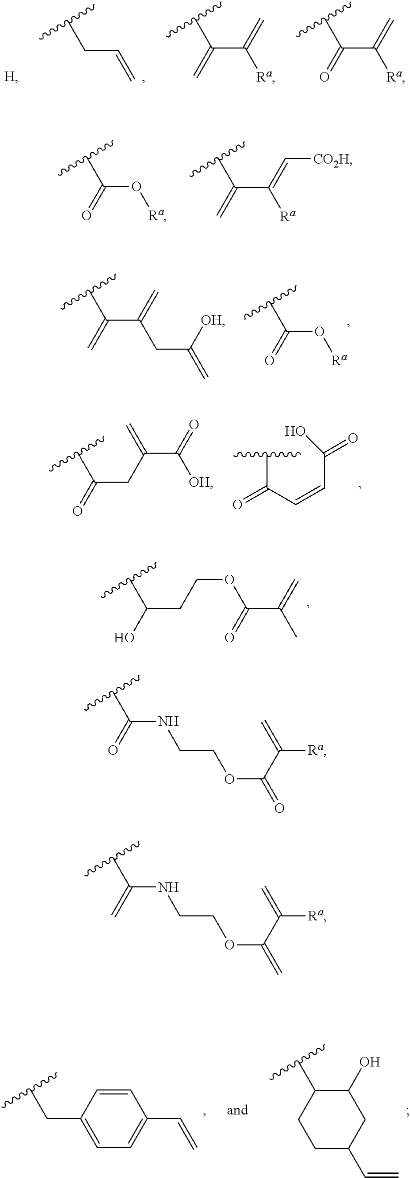
wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

8. The composition of claim 1, wherein the antimicrobial copolymer comprises a first curable or reactive group and a second curable or reactive group, each of which is thermally and/or actinically curable.

9. The composition of claim 8, wherein the antimicrobial copolymer is defined by Formula III: 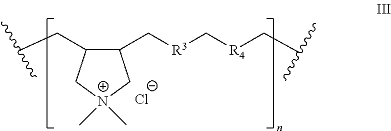
wherein
R³ comprises the first curable or reactive group;
R⁴ comprises the second curable or reactive group; and
n is an integer from 1 to 10,000.

10. The composition of claim 9, wherein R³ and/or R⁴ are independently selected from the group consisting of: 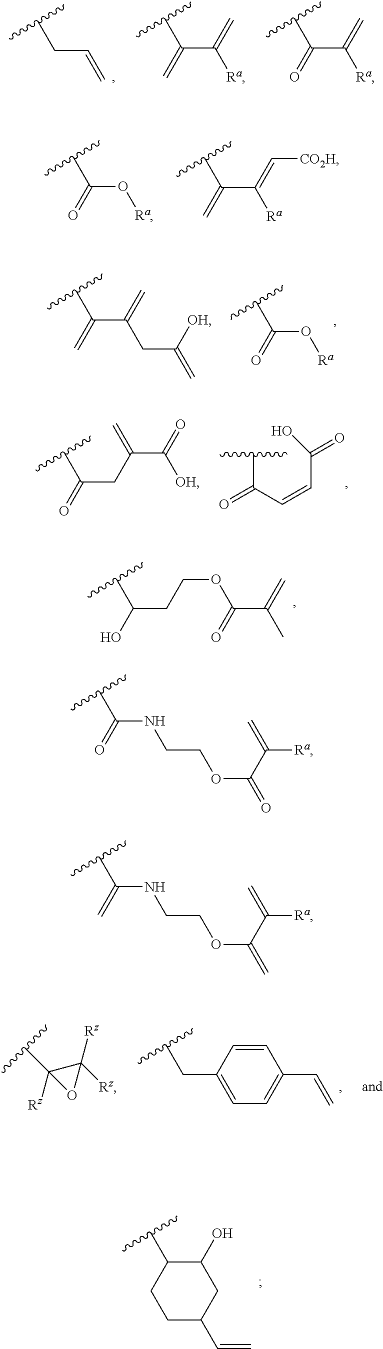
wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy(alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

11. The composition of claim 8, wherein the antimicrobial copolymer is defined by Formula IV: 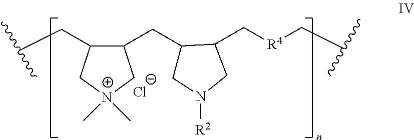
wherein
R² comprises the first curable or reactive group;
R⁴ comprises the second curable or reactive group; and
n is an integer from 1 to 10,000.

12. The composition of claim 11, wherein R² is selected from the group consisting of: 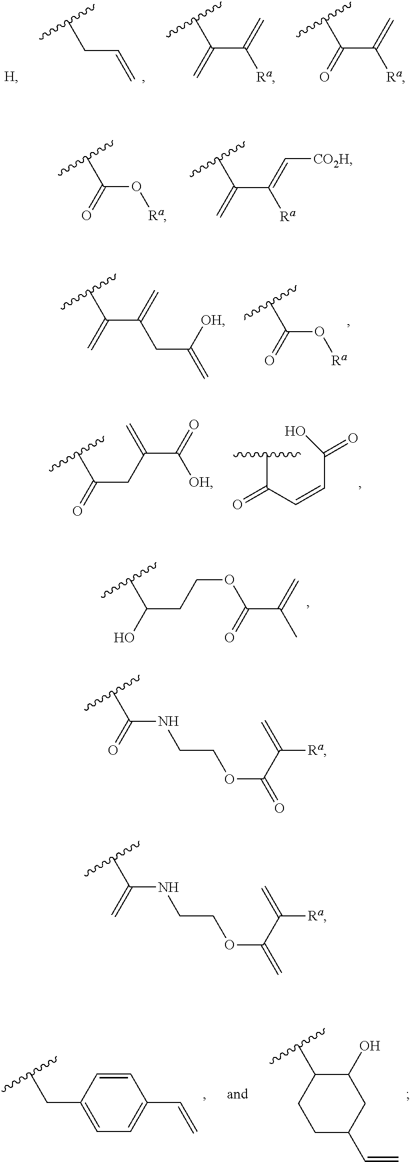
wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

13. The composition of claim 11, wherein R⁴ is selected from the group consisting of: 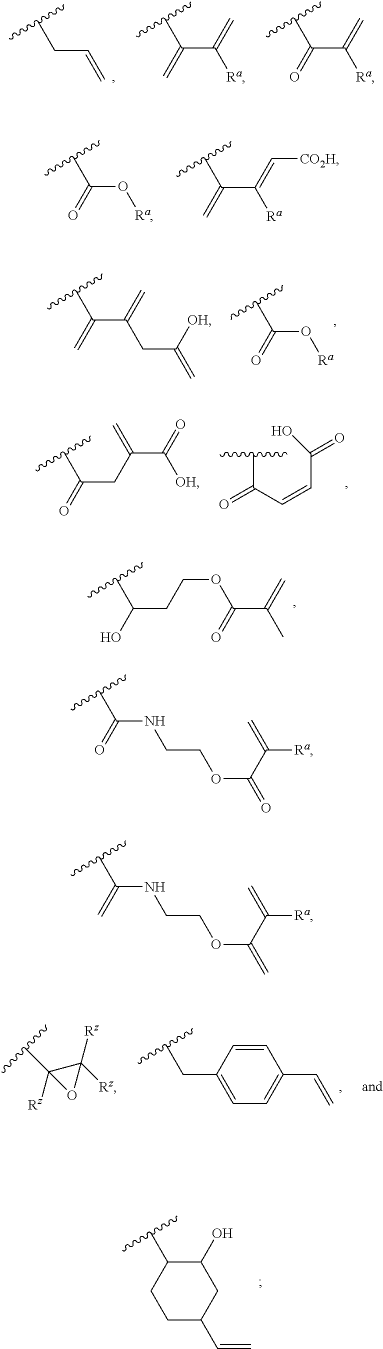
wherein
R^{a} is H, alkyl, or cycloalkyl, either of which is optionally substituted with halide, hydroxy, alkylthiol, carbonyl, alkoxy, alkylhydroxy, carboxyl, amino, amido, epoxy, alkyl, alkenyl, alkynyl, aryl, 3-(Trimethoxysilyl)alkyl, Hydroxyalkoxy (alkylylbis(trimethylsilyloxy)-methylsilane, —NR^{x}R^{y}, —C(O)NR^{x}R^{y}, or a combination thereof;
each R^{z} is independently H, alkyl, or cycloalkyl, either of which is optionally substituted with halide, carbonyl, alkoxy, carboxyl, amido, epoxy, alkyl, alkenyl, 3-(Trimethoxysilyl)alkyl, Hydroxyalkoxy (alkylylbis(trimethylsilyloxy)-methylsilane, alkynyl, aryl, —NR^{x}R^{y}, —C(O)NR^{x}R^{y}, or a combination thereof; and
R^{x} and R^{y} are independently H, OH, alkyl, alkenyl, alkynyl, cycloalkyl, aryl, alkylaryl, or heteroaryl.

14. The composition of claim 1, wherein the antimicrobial copolymer comprises: 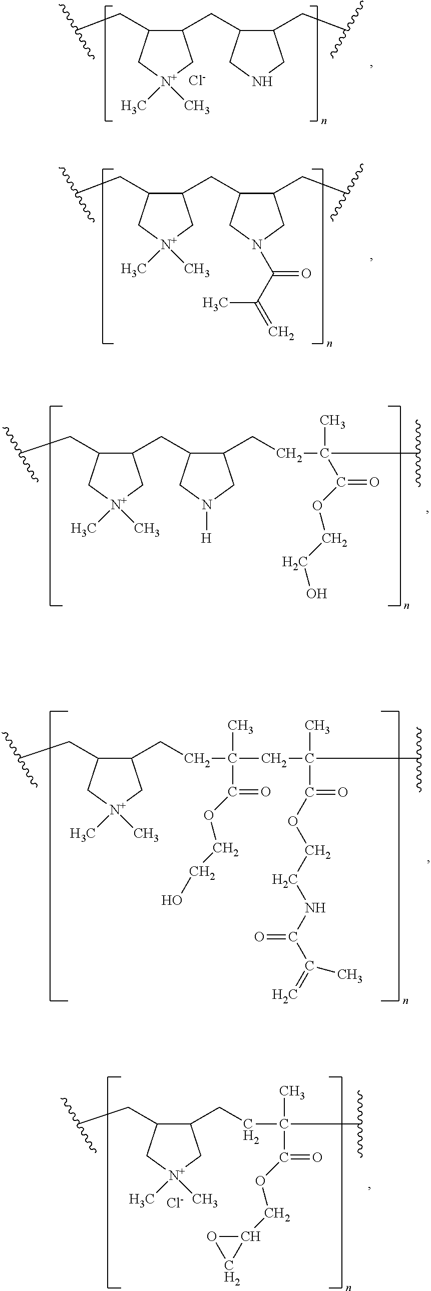 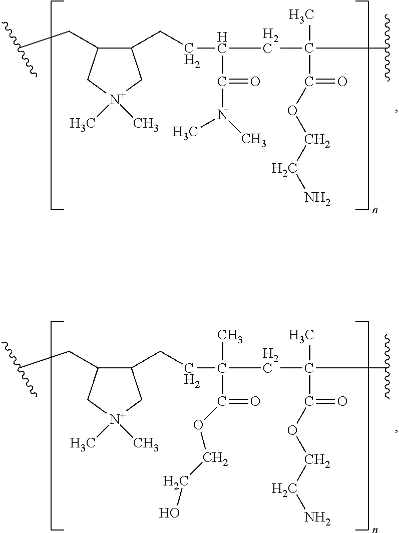
or a combination thereof, wherein each n is independently from 1 to 10,000.

15. The composition of claim 1, wherein the composition further comprises an additional antimicrobial agent.

16. The composition of claim 1, wherein the composition is non-leaching.

17. The composition of claim 1, wherein the composition exhibits antimicrobial activity.

18. A crosslinked composition comprising the composition of claim 1 crosslinked with a crosslinker.

19. A method of use of the composition of claim 1, wherein the method comprises using the composition in a medical device, an ophthalmic device, a wound dressing, or a combination thereof.

20. An article of manufacture comprising the composition of claim 1, wherein the article of manufacture comprises a medical device, an ophthalmic device, a wound dressing, or a combination thereof.
